(19) United States
(12) Patent Application Publication
(10) Pub. No.: US 2012/0263317 A1
(43) Pub. Date: Oct. 18, 2012

(54) SYSTEMS, METHODS, APPARATUS, AND COMPUTER READABLE MEDIA FOR EQUALIZATION

(75) Inventors: Jongwon Shin, San Diego, CA (US); Erik Visser, San Diego, CA (US); Jeremy P. Toman, San Diego, CA (US)

(73) Assignee: QUALCOMM Incorporated, San Diego, CA (US)

(21) Appl. No.: 13/444,735

(22) Filed: Apr. 11, 2012

Related U.S. Application Data
(60) Provisional application No. 61/475,082, filed on Apr. 13, 2011.

(51) Int. Cl. H04B 15/00

(52) U.S. Cl. 381/94.7

(57) ABSTRACT

Enhancement of audio quality (e.g., speech intelligibility) in a noisy environment, based on subband gain control using information from a noise reference, is described.

### CLAIM OF PRIORITY UNDER 35 U.S.C. §119

The present Application for Patent claims priority to Provisional Application No. 61/475,082, Attorney Docket No. 100353P1, entitled “SYSTEMS, METHODS, APPARATUS, AND COMPUTER READABLE MEDIA FOR EQUALIZATION BASED ON LOUDNESS RESTORATION,” filed Apr. 13, 2011, and assigned to the assignee hereof.

### REFERENCE TO CO-PENDING APPLICATIONS FOR PATENT

The present Application for Patent is related to the following co-pending U.S. Patent Applications:

U.S. patent application Ser. No. 12/277,283, entitled “SYSTEMS, METHODS, APPARATUS, AND COMPUTER PROGRAM PRODUCTS FOR ENHANCED INTELLIGIBILITY,” filed Nov. 24, 2008, and assigned to the assignee hereof; and

U.S. patent application Ser. No. 12/765,554, entitled “SYSTEMS, METHODS, APPARATUS, AND COMPUTER-READABLE MEDIA FOR AUTOMATIC CONTROL OF ACTIVE NOISE CANCELLATION,” filed Apr. 22, 2010, and assigned to the assignee hereof.

### BACKGROUND

1. Field

This disclosure relates to audio signal processing.

2. Background

An acoustic environment is often noisy, making it difficult to hear a desired informational signal. Noise may be defined as the combination of all signals interfering with or degrading a signal of interest. Such noise tends to mask a desired reproduced audio signal, such as the far-end signal in a phone conversation. For example, a person may desire to communicate with another person using a voice communication channel. The channel may be provided, for example, by a mobile wireless handset or headset, a walkie-talkie, a two-way radio, a car-kit, or another communications device. The acoustic environment may have many uncontrollable noise sources that compete with the far-end signal being reproduced by the communications device. Such noise may cause an unsatisfactory communication experience. Unless the far-end signal may be distinguished from background noise, it may be difficult to make reliable and efficient use of it.

The effect of the near-end noise to the far-end listener and that of the far-end noise to the near-end listener can be reduced by traditional noise reduction algorithms, which try to estimate clean noiseless speech from the noisy microphone signals. However, traditional noise reduction algorithms are not typically useful for controlling the effect of the near-end noise to the near-end listener, as such noise arrives directly at the listener's ears. Automatic volume control (AVC) and SNR-based receive voice equalization (RVE) are two approaches that address this problem by amplifying the desired signal instead of modifying the noise signal.

### SUMMARY

A method according to a general configuration of using information from a near-end noise reference to process a reproduced audio signal includes applying a subband filter array to the near-end noise reference to produce a plurality of time-domain noise subband signals. This method includes, based on information from the plurality of time-domain noise subband signals, calculating a plurality of noise subband excitation values. This method includes, based on the plurality of noise subband excitation values, calculating a plurality of subband gain factors, and applying the plurality of subband gain factors to a plurality of frequency bands of the reproduced audio signal in a time domain to produce an enhanced audio signal. In this method, calculating a plurality of subband gain factors includes, for at least one of said plurality of subband gain factors, raising a value that is based on a corresponding noise subband excitation value to a power of alpha to produce a corresponding compressed value, wherein the subband gain factor is based on the corresponding compressed value and wherein alpha has a positive nonzero value that is less than one. Computer-readable storage media (e.g., non-transitory media) having tangible features that cause a machine reading the features to perform such a method are also disclosed.

An apparatus according to a general configuration for using information from a near-end noise reference to process a reproduced audio signal includes means for filtering the near-end noise reference to produce a plurality of time-domain noise subband signals. This apparatus also includes means for calculating, based on information from the plurality of time-domain noise subband signals, a plurality of noise subband excitation values. This apparatus also includes means for calculating, based on the plurality of noise subband excitation values, a plurality of subband gain factors; and means for applying the plurality of subband gain factors to a plurality of frequency bands of the reproduced audio signal in a time domain to produce an enhanced audio signal. In this apparatus, calculating a plurality of subband gain factors includes, for each of said plurality of subband gain factors, raising a value that is based on a corresponding noise subband excitation value to a power of alpha to produce a corresponding compressed value, wherein the subband gain factor is based on the corresponding compressed value and wherein alpha has a positive nonzero value that is less than one.

An apparatus according to another general configuration for using information from a near-end noise reference to process a reproduced audio signal includes a subband filter array configured to filter the near-end noise reference to produce a plurality of time-domain noise subband signals. This apparatus also includes a first calculator configured to calculate, based on information from the plurality of time-domain noise subband signals, a plurality of noise subband excitation values. This apparatus also includes a second calculator configured to calculate, based on the plurality of noise subband excitation values, a plurality of subband gain factors; and a filter bank configured to apply the plurality of subband gain factors to a plurality of frequency bands of the reproduced audio signal in a time domain to produce an enhanced audio signal. The second calculator is configured, for each of said plurality of subband gain factors, to raise a value that is based on a corresponding noise subband excitation value to a power of alpha to produce a corresponding compressed value, wherein the subband gain factor is based on the corresponding compressed value and wherein alpha has a positive nonzero value that is less than one.

### BRIEF DESCRIPTION OF THE DRAWINGS

FIG. 1 shows an articulation index plot.

FIG. 2 shows a power spectrum for a reproduced speech signal in a typical narrowband telephony application.

FIG. 3 shows an example of a typical speech power spectrum and a typical noise power spectrum.

FIG. 4A illustrates an application of automatic volume control to the example of FIG. 3.

FIG. 4B illustrates an application of subband equalization to the example of FIG. 3.

FIG. 5A illustrates a partial masking effect.

FIG. 5B shows a block diagram of a loudness perception model.

FIG. 6A shows a flowchart for a method M100 of using information from a near-end noise reference to process a reproduced audio signal according to a general configuration.

FIG. 6B shows a block diagram of an apparatus A100 for using information from a near-end noise reference to process a reproduced audio signal according to a general configuration.

FIG. 7A shows a block diagram of an implementation A110 of apparatus A100.

FIG. 7B shows a block diagram of a subband filter array FA110.

FIG. 8A illustrates a transposed direct form II for a general infinite impulse response (IIR) filter implementation.

FIG. 8B illustrates a transposed direct form II structure for a biquad implementation of an IIR filter.

FIG. 9 shows magnitude and phase response plots for one example of a biquad implementation of an IIR filter.

FIG. 10 includes a row of dots that indicate edges of a set of seven Bark scale subbands.

FIG. 11 shows magnitude responses for a set of four biquads.

FIG. 12 shows magnitude and phase responses for a set of seven biquads.

FIG. 13A shows a block diagram of a subband power estimate calculator PC100.

FIG. 13B shows a block diagram of an implementation PC110 of subband power estimate calculator PC100.

FIG. 13C shows a block diagram of an implementation GC110 of subband gain factor calculator GC100.

FIG. 13D shows a block diagram of an implementation GC210 of subband gain factor calculator GC110 and GC200.

FIG. 14A shows a block diagram of an implementation A200 of apparatus A100.

FIG. 14B shows a block diagram of an implementation GC120 of subband gain factor calculator GC110.

FIG. 15A shows a block diagram of an implementation XC110 of subband excitation value calculator XC100.

FIG. 15B shows a block diagram of an implementation XC120 of subband excitation value calculator XC100 and XC110.

FIG. 15C shows a block diagram of an implementation XC130 of subband excitation value calculator XC100 and XC110.

FIG. 15D shows a block diagram of an implementation GC220 of subband gain factor calculator GC210.

FIG. 16 shows a plot of ERB in Hz vs. center frequency for a human auditory filter.

FIGS. 17A-17D show magnitude responses for the biquads of a four-subband narrowband scheme and corresponding ERBs.

FIG. 18 shows a block diagram of an implementation EF110 of equalization filter array EF100.

FIG. 19A shows a block diagram of an implementation EF120 of equalization filter array EF100.

FIG. 19B shows a block diagram of an implementation of a filter as a corresponding stage in a cascade of biquads.

FIG. 20A shows an example of a three-stage cascade of biquads.

FIG. 20B shows a block diagram of an implementation GC150 of subband gain factor calculator GC120.

FIG. 21A shows a block diagram of an implementation A120 of apparatus A100.

FIG. 21B shows a block diagram of an implementation GC130 of subband gain factor calculator GC110.

FIG. 21C shows a block diagram of an implementation GC230 of subband gain factor calculator GC210.

FIG. 22A shows a block diagram of an implementation A130 of apparatus A100.

FIG. 22B shows a block diagram of an implementation GC140 of subband gain factor calculator GC120.

FIG. 22C shows a block diagram of an implementation GC240 of subband gain factor calculator GC220.

FIG. 23 shows an example of activity transitions for the same frames of two different subbands A and B of a reproduced audio signal.

FIG. 24 shows an example of a state diagram for smoother GS110 for each subband.

FIG. 25A shows a block diagram of an audio preprocessor AP10.

FIG. 25B shows a block diagram of an audio preprocessor AP20.

FIG. 26A shows a block diagram of an implementation EC12 of echo canceller EC 10.

FIG. 26B shows a block diagram of an implementation EC22a of echo canceller EC20a.

FIG. 27A shows a block diagram of a communications device D10 that includes an instance of apparatus A110.

FIG. 27B shows a block diagram of an implementation D20 of communications device D10.

FIGS. 28A to 28D show various views of a multi-microphone portable audio sensing device D100.

FIG. 29 shows a top view of headset D100 mounted on a user's ear in a standard orientation during use.

FIG. 30A shows a view of an implementation D102 of headset D100.

FIG. 30B shows a view of an implementation D104 of headset D100.

FIG. 30C shows a cross-section of an earcup EC10.

FIG. 31A shows a diagram of a two-microphone handset H100.

FIG. 31B shows a diagram of an implementation H110 of handset H100.

FIG. 32 shows front, rear, and side views of a handset H200.

FIG. 33 shows a flowchart of an implementation M200 of method M100.

FIG. 34 shows a block diagram of an apparatus MF100 according to a general configuration.

FIG. 35 shows a block diagram of an implementation MF200 of apparatus MF100.

### DETAILED DESCRIPTION

Handsets like PDAs and cellphones are rapidly emerging as the mobile speech communications devices of choice, serving as platforms for mobile access to cellular and internet networks. More and more functions that were previously performed on desktop computers, laptop computers, and office phones in quiet office or home environments are being performed in everyday situations like a car, the street, a café, or an airport. This trend means that a substantial amount of voice communication is taking place in environments where users are surrounded by other people, with the kind of noise content that is typically encountered where people tend to gather. Other devices that may be used for voice communications and/or audio reproduction in such environments include wired and/or wireless headsets, audio or audiovisual media playback devices (e.g., MP3 or MP4 players), and similar portable or mobile appliances.

Systems, methods, and apparatus as described herein may be used to support increased intelligibility of a received or otherwise reproduced audio signal, especially in a noisy environment. Such techniques may be applied generally in any transceiving and/or audio reproduction application, especially mobile or otherwise portable instances of such applications. For example, the range of configurations disclosed herein includes communications devices that reside in a wireless telephony communication system configured to employ a code-division multiple-access (CDMA) over-the-air interface. Nevertheless, it would be understood by those skilled in the art that a method and apparatus having features as described herein may reside in any of the various communication systems employing a wide range of technologies known to those of skill in the art, such as systems employing Voice over IP (VoIP) over wired and/or wireless (e.g., CDMA, TDMA, FDMA, and/or TD-SCDMA) transmission channels.

Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, estimating, and/or selecting from a plurality of values. Unless expressly limited by its context, the term “obtaining” is used to indicate any of its ordinary meanings, such as calculating, deriving, receiving (e.g., from an external device), and/or retrieving (e.g., from an array of storage elements). Unless expressly limited by its context, the term “selecting” is used to indicate any of its ordinary meanings, such as identifying, indicating, applying, and/or using at least one, and fewer than all, of a set of two or more. Where the term “comprising” is used in the present description and claims, it does not exclude other elements or operations. The term “based on” (as in “A is based on B”) is used to indicate any of its ordinary meanings, including the cases (i) “derived from” (e.g., “B is a precursor of A”), (ii) “based on at least” (e.g., “A is based on at least B”) and, if appropriate in the particular context, (iii) “equal to” (e.g., “A is equal to B” or “A is the same as B”). Similarly, the term “in response to” is used to indicate any of its ordinary meanings, including “in response to at least.”

References to a “location” of a microphone of a multi-microphone audio sensing device indicate the location of the center of an acoustically sensitive face of the microphone, unless otherwise indicated by the context. The term “channel” is used at times to indicate a signal path and at other times to indicate a signal carried by such a path, according to the particular context. Unless otherwise indicated, the term “series” is used to indicate a sequence of two or more items. The term “logarithm” is used to indicate the base-ten logarithm, although extensions of such an operation to other bases are within the scope of this disclosure. The term “frequency component” is used to indicate one among a set of frequencies or frequency bands of a signal, such as a sample (or “bin”) of a frequency domain representation of the signal (e.g., as produced by a fast Fourier transform) or a subband of the signal (e.g., a Bark scale or mel scale subband).

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, and/or system as indicated by its particular context. The terms “method,” “process,” “procedure,” and “technique” are used generically and interchangeably unless otherwise indicated by the particular context. The terms “apparatus” and “device” are also used generically and interchangeably unless otherwise indicated by the particular context. The terms “element” and “module” are typically used to indicate a portion of a greater configuration. Unless expressly limited by its context, the term “system” is used herein to indicate any of its ordinary meanings, including “a group of elements that interact to serve a common purpose.”

Any incorporation by reference of a portion of a document shall also be understood to incorporate definitions of terms or variables that are referenced within the portion, where such definitions appear elsewhere in the document, as well as any figures referenced in the incorporated portion. Unless initially introduced by a definite article, an ordinal term (e.g., “first,” “second,” “third,” etc.) used to modify a claim element does not by itself indicate any priority or order of the claim element with respect to another, but rather merely distinguishes the claim element from another claim element having a same name (but for use of the ordinal term). Unless expressly limited by its context, each of the terms “plurality” and “set” is used herein to indicate an integer quantity that is greater than one.

It may be assumed that in the near-field and far-field regions of an emitted sound field, the wavefronts are spherical and planar, respectively. The near-field may be defined as that region of space which is less than one wavelength away from a sound receiver (e.g., a microphone array). Under this definition, the distance to the boundary of the region varies inversely with frequency. At frequencies of two hundred, seven hundred, and two thousand hertz, for example, the distance to a one-wavelength boundary is about 170, forty-nine, and seventeen centimeters, respectively. It may be useful instead to consider the near-field/far-field boundary to be at a particular distance from the microphone array (e.g., fifty centimeters from a microphone of the array or from the centroid of the array, or one meter or 1.5 meters from a microphone of the array or from the centroid of the array).

The terms “coder,” “codec,” and “coding system” are used interchangeably to denote a system that includes at least one encoder configured to receive and encode frames of an audio signal (possibly after one or more pre-processing operations, such as a perceptual weighting and/or other filtering operation) and a corresponding decoder configured to produce decoded representations of the frames. Such an encoder and decoder are typically deployed at opposite terminals of a communications link. In order to support a full-duplex communication, instances of both of the encoder and the decoder are typically deployed at each end of such a link.

In this description, the term “sensed audio signal” denotes a signal that is received via one or more microphones, and the term “reproduced audio signal” denotes a signal that is reproduced from information that is retrieved from storage and/or received via a wired or wireless connection to another device. An audio reproduction device, such as a communications or playback device, may be configured to output the reproduced audio signal to one or more loudspeakers of the device. Alternatively, such a device may be configured to output the reproduced audio signal to an earpiece, other headset, or external loudspeaker that is coupled to the device via a wire or wirelessly. With reference to transceiver applications for voice communications, such as telephony, the sensed audio signal is the near-end signal to be transmitted by the transceiver, and the reproduced audio signal is the far-end signal received by the transceiver (e.g., via an active wireless communications link, such as during a telephone call). With reference to mobile audio reproduction applications, such as playback of recorded music, video, or speech (e.g., MP3-encoded music files, movies, video clips, audiobooks, podcasts) or streaming of such content, the reproduced audio signal is the audio signal being played back or streamed. Such playback or streaming may include decoding the content, which may be encoded according to a standard compression format (e.g., Moving Pictures Experts Group (MPEG)-1 Audio Layer 3 (MP3), MPEG-4 Part 14 (MP4), a version of Windows Media Audio/Video (WMA/WMV) (Microsoft Corp., Redmond, Wash.), Advanced Audio Coding (AAC), International Telecommunication Union (ITU)-T H.264, or the like), to recover the audio signal.

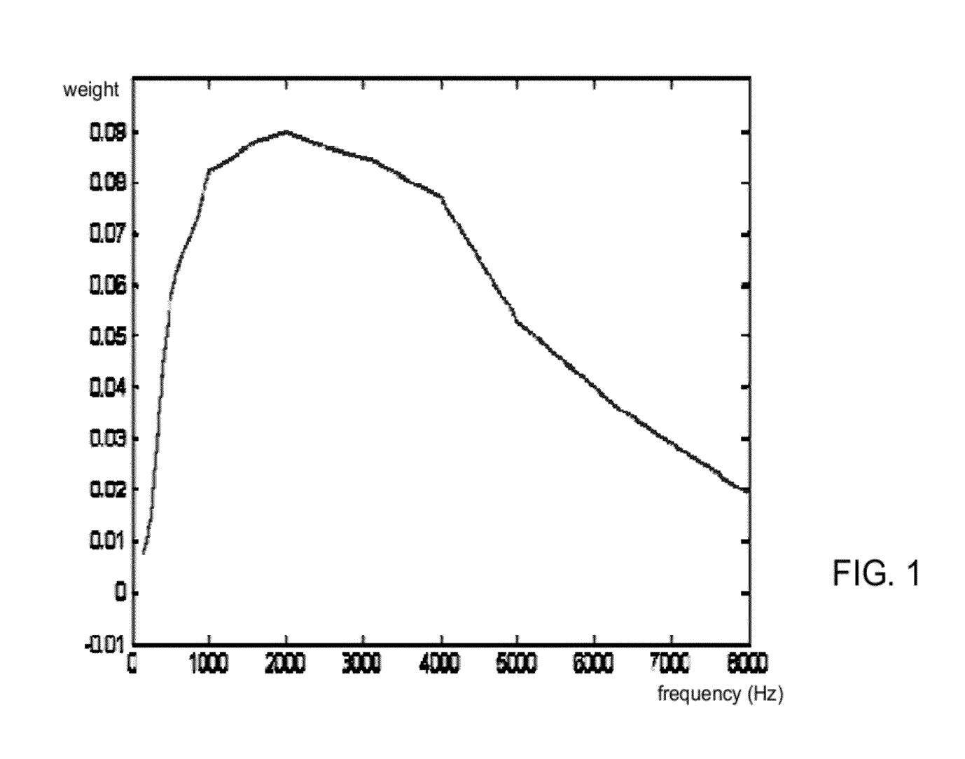

The intelligibility of a reproduced speech signal may vary in relation to the spectral characteristics of the signal. For example, the articulation index plot of FIG. 1 shows how the relative contribution to speech intelligibility varies with audio frequency. This plot illustrates that frequency components between 1 and 4 kHz are especially important to intelligibility, with the relative importance peaking around 2 kHz.

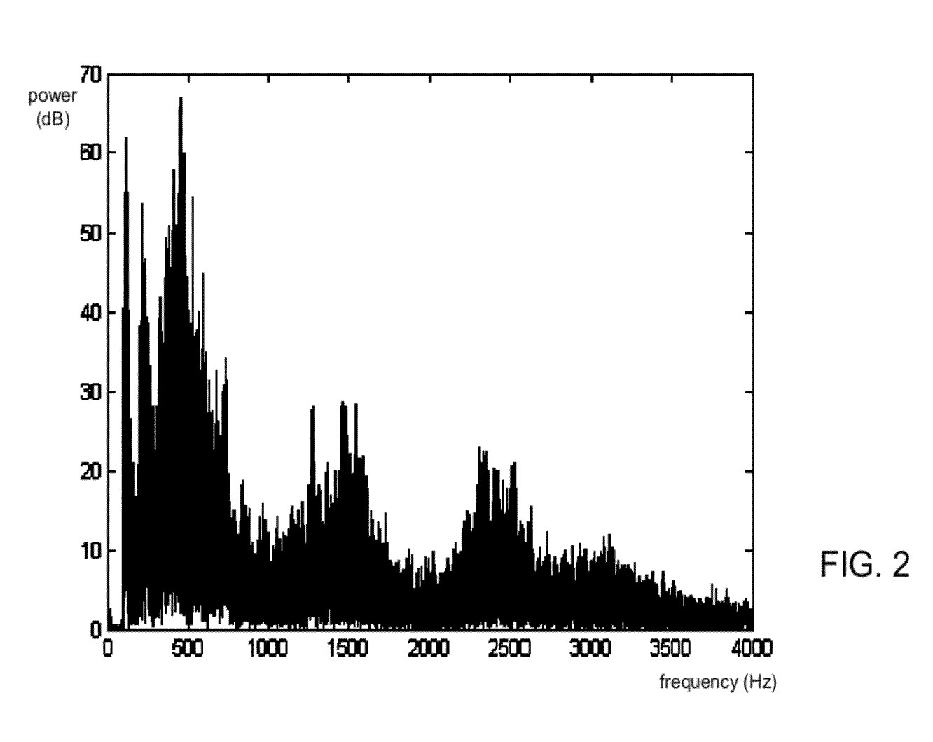

FIG. 2 shows a power spectrum for a reproduced speech signal in a typical narrowband telephony application. This diagram illustrates that the energy of such a signal decreases rapidly as frequency increases above 500 Hz. As shown in FIG. 1, however, frequencies up to 4 kHz may be very important to speech intelligibility.

As audio frequencies above 4 kHz are not generally as important to intelligibility as the 1 kHz to 4 kHz band, transmitting a narrowband signal over a typical band-limited communications channel is usually sufficient to have an intelligible conversation. However, increased clarity and better communication of personal speech traits may be expected for cases in which the communications channel supports transmission of a wideband signal. In a voice telephony context, the term “narrowband” refers to a frequency range from about 0-500 Hz (e.g., 0, 50, 100, or 200 Hz) to about 3-5 kHz (e.g., 3500, 4000, or 4500 Hz), the term “wideband” refers to a frequency range from about 0-500 Hz (e.g., 0, 50, 100, or 200 Hz) to about 7-8 kHz (e.g., 7000, 7500, or 8000 Hz), and the term “superwideband” refers to a frequency range from about 0-500 Hz (e.g., 0, 50, 100, or 200 Hz) to about 12-24 kHz (e.g., 12, 14, 16, 20, 22, or 24 kHz).

The real world abounds from multiple noise sources, including single point noise sources, which often transgress into multiple sounds resulting in reverberation. Background acoustic noise may include numerous noise signals generated by the general environment and interfering signals generated by background conversations of other people, as well as reflections and reverberation generated from each of the signals.

Environmental noise may affect the intelligibility of a reproduced audio signal, such as a far-end speech signal. For applications in which communication occurs in noisy environments, it may be desirable to use a speech processing method to distinguish a speech signal from background noise and enhance its intelligibility. Such processing may be important in many areas of everyday communication, as noise is almost always present in real-world conditions.

Automatic volume control (AVC) adjusts the overall power of the entire signal (e.g., amplifies the signal) according to the background noise level. Such an approach may be used to increase intelligibility of an audio signal being reproduced in a noisy environment. While such a scheme is maximally natural, potential weaknesses of AVC include a very slow response, weak performance (e.g., insufficient gain) in the presence of nonstationary noise, and/or weak performance in the presence of noise having a different spectral tilt than the speech signal (e.g., too large gain in the presence of vehicular noise, altered noise color in the presence of white noise, etc.).

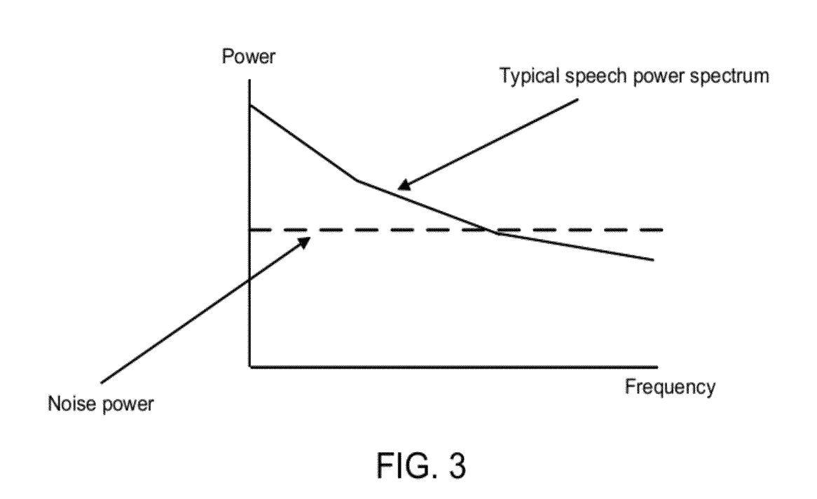

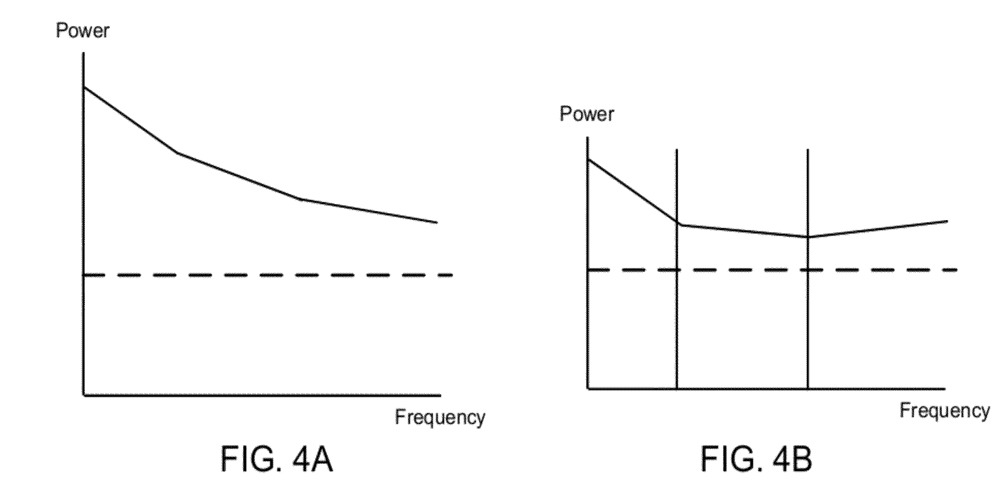

FIG. 3 shows an example of a typical speech power spectrum, in which a natural speech power roll-off causes power to decrease with frequency, and a typical noise power spectrum, in which power is generally constant over at least the range of speech frequencies. In such case, high-frequency components of the speech signal may have less energy than corresponding components of the noise signal, resulting in a masking of the high-frequency speech bands. FIG. 4A illustrates an application of AVC to such an example. An AVC module is typically implemented to boost all frequency bands of the speech signal indiscriminately, as shown in this figure. Such an approach may require a large dynamic range of the amplified signal for a modest boost in high-frequency power.

The gain applied by AVC is typically independent of speech signal level, although this effect may be somewhat mitigated with automatic gain control (AGC). An AGC technique may be used to compress the dynamic range of the reproduced audio signal into a limited amplitude band, thereby boosting segments of the signal that have low power and decreasing energy in segments that have high power. In response to high noise levels, an AVC scheme may also generate speech that is too loud.

Background noise typically drowns high-frequency speech content much more quickly than low-frequency content, since speech power in high-frequency bands is usually much smaller than in low-frequency bands. Therefore simply boosting the overall volume of the signal may unnecessarily boost low-frequency content below 1 kHz which may not significantly contribute to intelligibility. It may be desirable instead to adjust audio frequency subband power to compensate for noise masking effects on a reproduced audio signal. For example, it may be desirable to boost speech power in inverse proportion to the ratio of noise-to-speech subband power, and disproportionally so in high-frequency subbands, to compensate for the inherent roll-off of speech power towards high frequencies.

It may be desirable to compensate for low voice power in frequency subbands that are dominated by environmental noise. It has also been suggested to selectively amplify frequencies of the desired signal that are masked by the surrounding noise so that these frequencies are no longer masked. As shown in FIG. 4B, it may be desirable to act on selected subbands to boost intelligibility by applying different gain boosts to different subbands of the speech signal (e.g., according to a speech-to-noise ratio in the subband). In contrast to the AVC example shown in FIG. 4A, such equalization may be expected to provide a clearer and more intelligible signal, while avoiding an unnecessary boost of low-frequency components.

It may be desirable to implement an equalization scheme that amplifies the signal (e.g., a reproduced audio signal, such as far-end speech, that is free from the near-end noise) in each of one or more bands. Such amplification may be based, for example, on a level of the near-end noise in the band. As compared to a noise suppression scheme in the transmit chain, which reduces the effect of the near-end noise on the outgoing speech and thus benefits the far-end listener, such an equalization scheme may be expected to reduce the effect of near-end noise on incoming speech and thus to benefit to the near-end listener.

An equalization scheme may be configured to make the output SNR (e.g., ratio of far-end speech to near-end noise) in each band equal to or larger than a predetermined value. For example, such a scheme may be designed to make the output SNR in each band the same. One example of such an equalization scheme uses four bands for narrowband speech (e.g., 0 or about 50 or 300 Hz to about 3000, 3400, or 3500 Hz) and six bands for wideband speech (e.g., 0 or about 50 or 300 Hz to about 7, 7.5, or 8 kHz).

As compared to at least some AVC schemes, an SNR-based equalization scheme enables frequency-selective (e.g., frequency-dependent) amplification and may be implemented to cope with noises having various spectral tilts. An equalization scheme also tends to react faster to nonstationary noise than at least some AVC schemes, although an automatic gain control (AGC) module might be modified to incorporate a noise reference generated by an external module (e.g., a transmit ECNS (echo cancellation noise suppression) module). The gain of at least some AVC schemes is determined by the background (near-end) noise level, while the gain of an equalization scheme may be determined by the background noise level and also by the far-end speech level. An equalization scheme may be configured to have arbitrary band gain and tends to produce more intelligible sound than at least some AVC schemes.

As SNR does not directly relate to human perception, however, an SNR-based equalization scheme may alter voice color. Temporal smoothing may be an important part of an SNR-based equalization scheme, as without it the output signal may sound like noise. Unfortunately, such smoothing may result in a rather slow response. If an SNR-based equalization scheme is configured such that the output level is independent of input speech signal level, it may produce a sound that is too tinny and that may be annoying at high noise levels. Unless an SNR-based equalization scheme is implemented to include a far-end voice activity detector (VAD), the scheme may amplify silent periods too much. It may also be desirable for an SNR-based equalization scheme to include gain modification (e.g., to reduce muffling and/or to resolve overlapping between biquads). Further description and examples of SNR-based equalization schemes, including schemes that use biquad filters to estimate the powers of the near-end noise and the far-end signal and a cascaded biquad filter structure to amplify the far-end signal, may be found in, e.g., US Publ. Pat. Appls. Nos. 2010/0017205 (Jan. 21, 2010, Visser et al.) and 2010/0296668 (Nov. 25, 2010, Lee et al.).

A near-end equalization scheme may be designed with an aim to maintain the quality and/or intelligibility of the received speech in the presence of near-end background noise. It may be desirable to design such a scheme to restore a characteristic of the desired signal, rather than to improve a characteristic of the signal like many other modules. For example, it may be desirable to restore a perceived loudness of the desired signal.

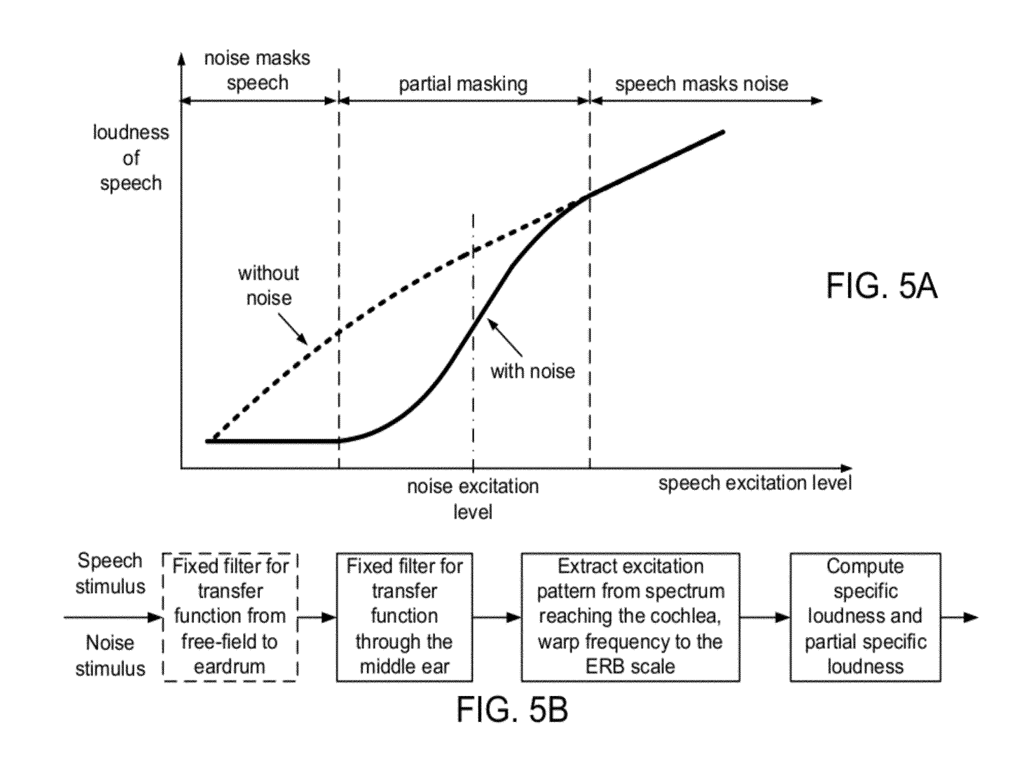

The loudness of a signal decreases in the presence of an interfering signal. This effect is called “partial masking.” FIG. 5A illustrates a partial masking effect that almost everyone has experienced in daily life, for example when one listens to music or has a conversation over a mobile phone in the presence of noise. This effect causes the perceived loudness of a signal to be diminished in the presence of another signal (i.e., a masking signal). The loudness of a masked signal when a masking signal is present is called “partial loudness” or “partial masked loudness.” (It is expressly noted that FIG. 5A is illustrative only. For example, the loudness of the speech below the masking threshold continuously decreases rather than being zero as shown.)

It may be considered that, in contrast to approaches such as those described above (e.g., AVC, AGC, and SNR-based equalization), an equalization approach based on loudness perception identifies the reason for degradation of audio quality and speech intelligibility in the presence of background noise as the diminishment of the perceived loudness of the audio signal. Such an approach may be designed to try to restore the original loudness of the audio signal (e.g., the far-end speech) in each band, such that the loudness of the speech in each band in the presence of background noise is the same as the loudness of the original noiseless far-end speech. For example, the scheme may be designed to make the partial loudness of a reinforced speech signal in a frequency band to be at least substantially the same as (e.g., within two, five, ten, fifteen, twenty, or twenty-five percent of) the loudness of the noiseless speech signal in that frequency band.

A frequency-domain implementation of near-end speech reinforcement based on loudness perception has been described in J. W. Shin et al, “Perceptual Reinforcement of Speech Signal Based on Partial Specific Loudness,” IEEE Sig. Proc. Letters, vol. 14, no. 11, November 2007, pp. 887-890. Unless an impractically large number of transform coefficients is used, however, such a frequency-domain approach may lack sufficient resolution at low frequencies to support accurate mapping to a loudness perception model. For a 512-point fast Fourier transform (FFT) at a sampling rate of 16 kHz, for example, adjacent frequency-domain samples are separated by 31.25 Hz, such that a low-frequency subband may be represented by only one or two samples in the frequency domain. Such sparse sampling may be insufficient to support an accurate estimation of perceived loudness in a low-frequency subband. As noted above, low frequencies may be especially important to speech intelligibility.

Systems, methods, and apparatus for enhancement of audio quality (e.g., speech intelligibility) in a noisy environment are described. Particular examples include schemes that are based on partial loudness restoration, time-domain excitation estimation, and a biquad cascade structure. A scheme as described herein may be applied to any audio playback system which may operate within a noisy environment.

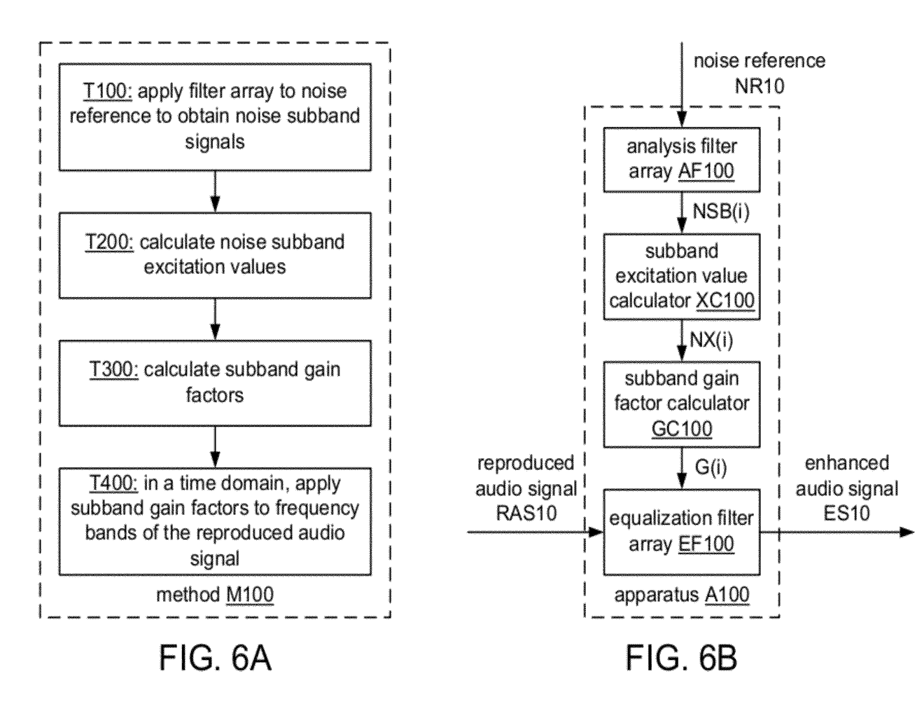

FIG. 6A shows a flowchart for a method M100 of using information from a near-end noise reference to process a reproduced audio signal according to a general configuration that includes tasks T100, T200, T300, and T400. Task T100 applies a subband filter array to the near-end noise reference to produce a plurality of time-domain noise subband signals. Based on information from the plurality of time-domain noise subband signals, task T200 calculates a plurality of noise subband excitation values. Based on the plurality of noise subband excitation values, task T300 calculates a plurality of subband gain factors. For at least one of the subband gain factors, calculating the subband gain factor includes raising a value that is based on the noise subband excitation value to a power of α, where 0<α<1, to produce a corresponding compressed value, and each of the subband gain factors is based on the corresponding compressed value. Task T400 applies the plurality of subband gain factors to a plurality of frequency bands of the reproduced audio signal in a time domain to produce an enhanced audio signal. Because of the relation between compression of the excitation values and the auditory mechanism of loudness perception, method M100 is referred to herein as a loudness-perception-based (LP-based) method.

As compared to an SNR-based equalization approach that aims to obtain the same output SNR in each band, method M100 may be implemented to restore the loudness of the reproduced audio signal in each band. While the target SNR in an SNR-based equalization scheme may be somewhat arbitrary, so that the reason for applying a particular gain value to a band may be poorly defined, method M100 may be configured to amplify the reproduced audio signal (e.g., the far-end speech) in each band by a specific amount whose relation to the inputs is more apparent. Method M100 may also provide a more constant loudness across various types of noise in practice.

FIG. 6B shows a block diagram of an apparatus A100 for using information from a near-end noise reference to process a reproduced audio signal according to a general configuration. Such an apparatus may be used to perform implementations of method M100 as described herein. Apparatus A100 includes an analysis filter array AF100, an excitation value calculator XC100, a gain factor calculator GC100, and an equalization filter array EF100. Analysis filter array AF100, which may be used to perform an instance of task T100, is configured to filter the near-end noise reference NR10 to generate a plurality of noise subband signals. Subband excitation value calculator XC100, which may be used to perform an instance of task T200, is configured to calculate a plurality of noise excitation values based on information from the plurality of noise subband signals. Subband gain factor calculator GC100, which may be used to perform an instance of task T300, is configured to produce a plurality of subband gain factors based on the plurality of noise excitation values. Equalization filter array EF100, which may be used to perform an instance of task T400, applies the gain factors to subbands of the reproduced (e.g., far-end) audio signal RAS10 to produce an enhanced audio signal ES10.

Without temporal smoothing of the subband gain factors, the output signal produced by an SNR-based equalization scheme may sound like noise. An LP-based equalization scheme, such as method M100, typically requires less temporal smoothing of the subband gain factors and may even be implemented without such smoothing, allowing such a scheme to react more quickly than an SNR-based equalization. Without far-end voice activity detection (VAD), an SNR-based equalization scheme may amplify periods of silence too much, while the importance of far-end VAD is reduced for an LP-based equalization scheme, which may even be implemented without it. While it may be desirable for an SNR-based equalization to include gain modification (e.g., to reduce muffling and/or to reduce overlapping between biquads), an LP-based equalization scheme typically requires less tuning effort.

An LP-based equalization approach, such as method M100, may be used to produce an output which preserves voice color in the presence of noise. An LP-based equalization scheme may be implemented to selectably and independently control the relative loudness of the output in each band. Controllability of the output loudness in each band may be used to produce a modified output that shows the loudness of speech in the i-th band to be kᵢ times of the original loudness in that band (e.g., as described herein with reference to band-weighting parameters k). Controllability of the output loudness in each band may be used to control a trade-off between naturalness and intelligibility and can be potentially applied differently according to the SNR (e.g., to produce louder speech at lower SNR). An LP-based equalization scheme may be implemented to provide more consistent loudness across various noise conditions (e.g., consistent loudness of the far-end speech signal over various levels and kinds of near-end noises), which may allow the end user to be virtually free from use of the volume control. An LP-based equalization scheme may be configured to preserve input speech loudness regardless of input and noise levels (over a moderate range). An LP-based equalization scheme may be implemented also to enable faster response to nonstationary noise, leading to strong performance in the presence of nonstationary noise (e.g., voice noise, such as a competing talker). It is possible that an LP-based equalization scheme will have greater computational complexity than a comparably configured SNR-based equalization scheme.

Subband gain factor calculator GC100 may be implemented to apply a loudness perception model that is expressed as a mathematical model for the loudness of the signal in each band when an interfering signal is present. Ideally, such an approach can be used to make the perception of enhanced audio signal ES10, in the presence of the near-end noise, to be exactly the same as that of reproduced audio signal RAS10 in the absence of noise. The subband gain factors G(i) may be determined, based on the loudness perception model, as a function of noise level in each subband and possibly of signal level in each subband.

FIG. 5B shows a block diagram of a loudness perception model, which may be used to derive specific loudness and partial loudness values for the near-end noise. Such a model may also be used to separately derive specific loudness and partial loudness values for the desired signal (e.g., far-end speech). In a practical application, it may be acceptable to implement only a selected subset of the elements of this model. For example, it may be acceptable to omit the auditory filter in the third block of FIG. 5B that extracts the excitation pattern from the spectrum reaching the cochlea, as the peak of this filter is 1.0.

Near-end noise reference NR10 may be based on a sensed audio signal. For example, the near-end noise reference may be based on acoustic environment of a user of a device that includes an instance of apparatus A100 or otherwise performs an instance of method M100. Such a noise reference may be based on a signal produced by a microphone that is located, during a use of apparatus A100 or an execution of method M100, within two, five, or ten centimeters of the user's ear canal. Such a microphone may be worn on or otherwise located at a head of the user. For example, such a microphone may be worn on or held to an ear of the user during such use or execution. Examples of devices that may be implemented to include an instance of apparatus A100 or otherwise to perform an instance of method M100 include a wired or wireless headset, a telephone, a smartphone, and an earcup for active noise cancellation (ANC) applications. Examples of such devices are described in further detail herein.

Producing the noise reference may include distinguishing the user's speech from other environmental sound. For example, producing a single-channel noise reference from a microphone signal may include comparing an energy of the signal in each of one or more frequency bands to a corresponding threshold value to distinguish active speech frames from inactive frames, and time-averaging the inactive frames to produce the noise reference. In another example, a single-channel noise reference is calculated using a minimum statistics approach. Such an approach may be performed, for example, by tracking the minimum of the noise signal PSD (e.g., as described by Rainer Martin in “Noise Power Spectral Density Estimation Based on Optimum Smoothing and Minimum Statistics,” IEEE Trans. on Speech and Audio Proc., vol. 9, no. 5, July 2001).

In some cases, a multichannel sensed audio signal may be available, in which each channel is produced by a different microphone in a microphone array that is disposed to sense the acoustic environment. Each microphone of the array may be located, during a use of apparatus A100 or an execution of method M100, within two, five, or ten centimeters of another microphone of the array, with at least one microphone of the array being located within two, five, or ten centimeters of the user's ear canal. A fixed or adaptive beamformer may be applied to such a multichannel signal to produce the noise reference by attenuating, in one or more of the channels, signal components arriving from a direction that is associated with a desired sound source.

In practical applications, it may be difficult to model the environmental noise from a sensed audio signal using traditional single-microphone or fixed beamforming methods. Although FIG. 3 suggests a noise level that is constant with frequency, the environmental noise level in a practical application of a communications device or a media playback device typically varies significantly and rapidly over both time and frequency.

The acoustic noise in a typical environment may include babble noise, airport noise, street noise, voices of competing talkers, and/or sounds from interfering sources (e.g., a TV set or radio). Consequently, such noise is typically nonstationary and may have an average spectrum is close to that of the user's own voice. A noise power reference signal as computed from a single microphone signal is usually only an approximate stationary noise estimate. Moreover, such computation generally entails a noise power estimation delay, such that corresponding adjustments of subband gains can only be performed after a significant delay. It may be desirable to obtain a reliable and contemporaneous estimate of the environmental noise.

Method M100 and/or apparatus A100 may be implemented to generate the near-end noise reference by performing a spatially selective processing (SSP) operation on a multichannel sensed audio signal. Such an operation may include calculating differences of phase and/or gain between channels of the signal to indicate a direction of arrival (e.g., relative to an axis of the microphone array) of each of one or more frequency components of the signal. For example, the value of Δφ/f is ideally the same for all frequency components of the signal that arrive from the same direction, where Δφ denotes the difference calculated by the SSP operation between the phase of the component at frequency f in a first channel of the signal and the phase of the component at frequency f in a second channel of the signal. Similarly, an SSP operation may be implemented to determine a direction of arrival of a frequency component in terms of time difference of arrival by calculating a gain difference between the gain of the frequency component in each channel. A single direction of arrival (DOA) for a frame of the signal may also be calculated based on a difference between the energies of the frame in each channel. For a case in which more than two microphone channels are available, the SSP operation may be implemented to indicate and combine DOAs for each of two or more pairs of the channels (e.g., to obtain a DOA in a two- or three-dimensional space).

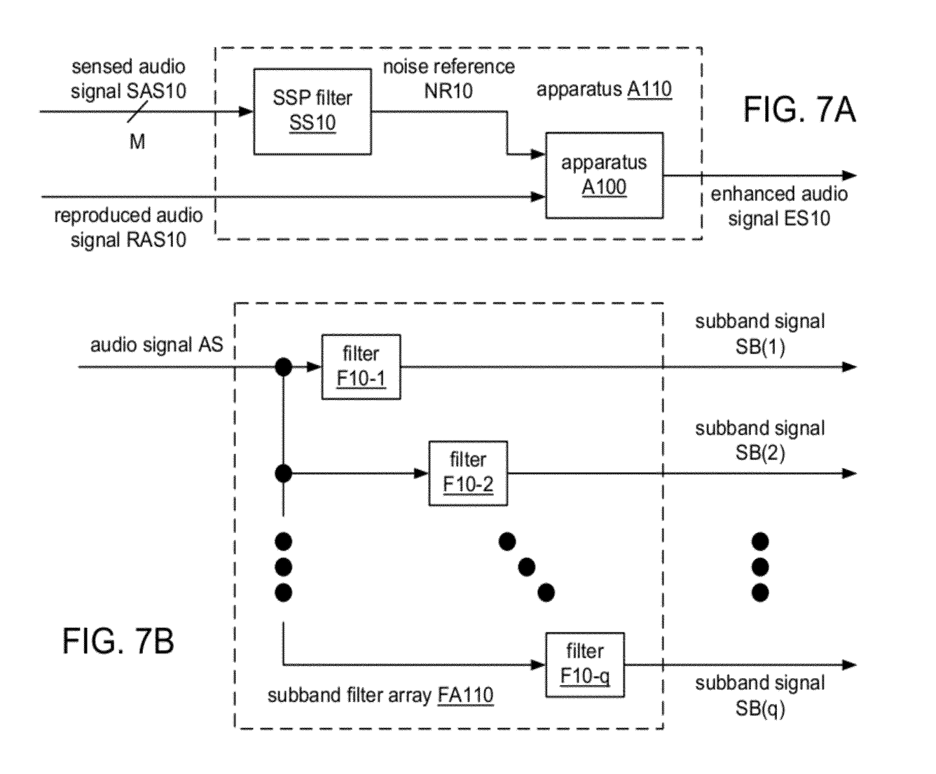

FIG. 7A shows a block diagram of an implementation A110 of apparatus A100 that includes a SSP filter SS10 configured to perform one or more SSP operations as described herein on an M-channel sensed audio signal SAS10 (where M>1, e.g., 2, 3, 4, or 5) to produce near-end noise reference NR10. Method M100 and/or apparatus A100 (e.g., SSP filter SS10) may be implemented to include producing the near-end noise reference from a multichannel sensed audio signal by attenuating, in one or both channels, frequency components that share a dominant DOA of the signal (alternatively, by attenuating frequency components having a DOA that is associated with a desired sound source). By avoiding the lag associated with generating a single-channel noise reference, such a noise reference may be expected to capture more of the nonstationary environmental than a single-channel noise reference. The near-end noise reference may also be based on a combination (e.g., a weighted sum) of two or more noise references as described herein, where each of these component noise references is a single-channel or a multichannel (e.g., dual-channel) noise reference.

It may be desirable to obtain the near-end noise reference from microphone signals that have undergone an echo cancellation operation (e.g., as described herein with reference to audio preprocessor AP20 and echo canceller EC10). If acoustic echo remains in the near-end noise reference, then a positive feedback loop may be created between the enhanced audio signal and the subband gain factor computation path, such that the louder the enhanced audio signal drives a near-end loudspeaker, the more that apparatus A100 or method M100 will tend to increase the subband gain factors.

Analysis filter array AF100 may be implemented to include two or more component filters (e.g., a plurality of subband filters) that are configured to produce different subband signals in parallel. FIG. 7B shows a block diagram of such a subband filter array FA110 that includes an array of q bandpass filters F10-1 to F10-q arranged in parallel to perform a subband decomposition of a time-domain audio signal AS. Each of the filters F10-1 to F10-q is configured to filter audio signal AS to produce a corresponding one of the q subband signals SB(1) to SB(q). An instance of any of the implementations of array FA110 as described herein may be used to implement analysis filter array AF100 such that audio signal AS corresponds to noise reference NR10 and the subband signals SB(1) to SB(q) correspond to the noise subband signals NSB(i).

Each of the filters F10-1 to F10-q may be implemented to have a finite impulse response (FIR) or an infinite impulse response (IIR). For example, each of one or more (possibly all) of filters F10-1 to F10-q may be implemented as a second-order IIR section or “biquad”. The transfer function of a biquad may be expressed as

$$H ( z ) = \frac{{b}_{0} + {b}_{1} {z}^{- 1} + {b}_{2} {z}^{- 2}}{1 + {a}_{1} {z}^{- 1} + {a}_{2} {z}^{- 2}} . \qquad ( 1 )$$

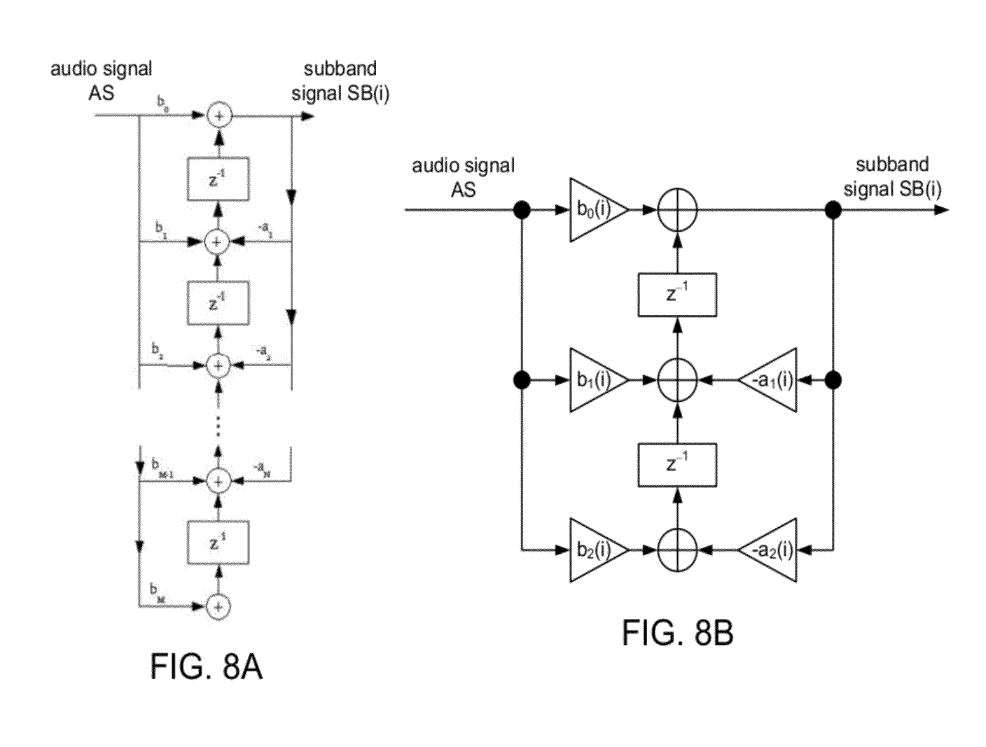

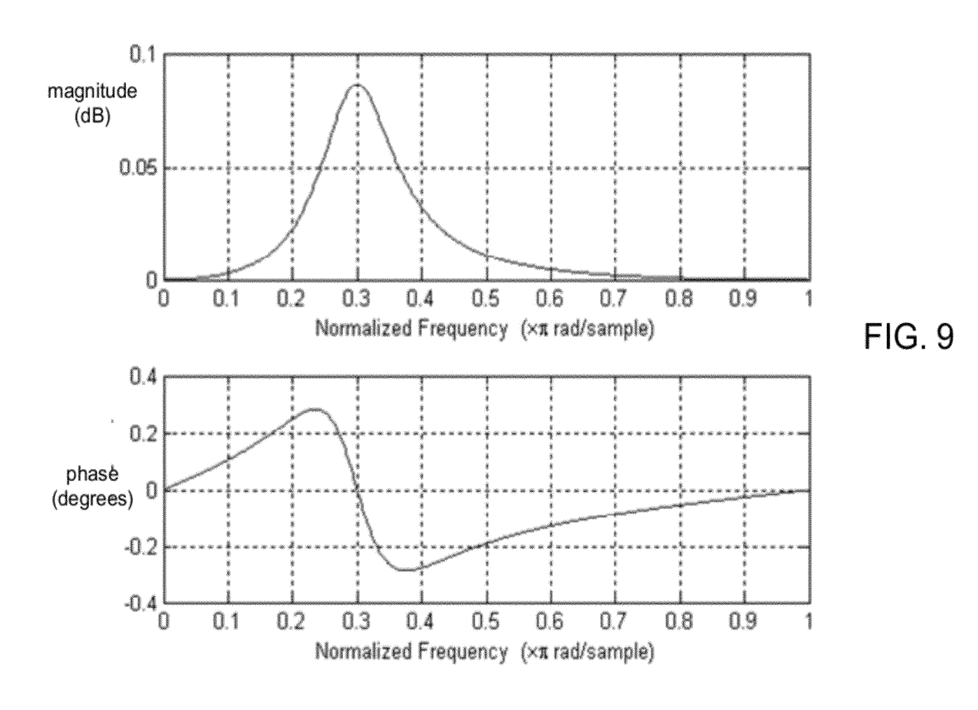

It may be desirable to implement each biquad using the transposed direct form II, especially for floating-point implementations of apparatus A100. FIG. 8A illustrates a transposed direct form II for a general IIR filter implementation of one of filters F10-1 to F10-q, and FIG. 8B illustrates a transposed direct form II structure for a biquad implementation of one F10-i of filters F10-1 to F10-q. FIG. 9 shows magnitude and phase response plots for one example of a biquad implementation of one of filters F10-1 to F10-q.

Several examples of algorithms for the design of biquad implementations of peaking filters (also called equalization filters) are known. One example of a design algorithm that may be used for a biquad implementation of subband filter array FA110 is based on the following two intermediate variables:

$${α}_{i} = \frac{tan ( π \frac{{BW}_{i}}{{f}_{s}} ) - 1}{tan ( π \frac{{BW}_{i}}{{f}_{s}} ) + 1} , {β}_{i} = - cos 2 π \frac{{f}_{p\_i}}{{f}_{s}} ,$$

where BWᵢ denotes bandwidth of the passband of filter F10-i, fₚ_{_{—}}ᵢ denotes peak frequency of filter F10-i, and fₛ denotes sampling frequency. The coefficients for each filter F10-i may be computed in terms of these intermediate variables as:

$$b {0}_{i} = 1 + {10}^{{g}_{i} / 20} \frac{( 1 + {α}_{i} )}{2} , b {1}_{i} = {β}_{i} ( 1 - {α}_{i} ) , \\ b {2}_{i} = - {α}_{i} - {10}^{{g}_{i} / 20} \frac{( 1 + {α}_{i} )}{2} , a {1}_{i} = b {1}_{i} , a {2}_{i} = - {α}_{i} ,$$

where a0ᵢ=1 and gᵢ denotes gain in dB.

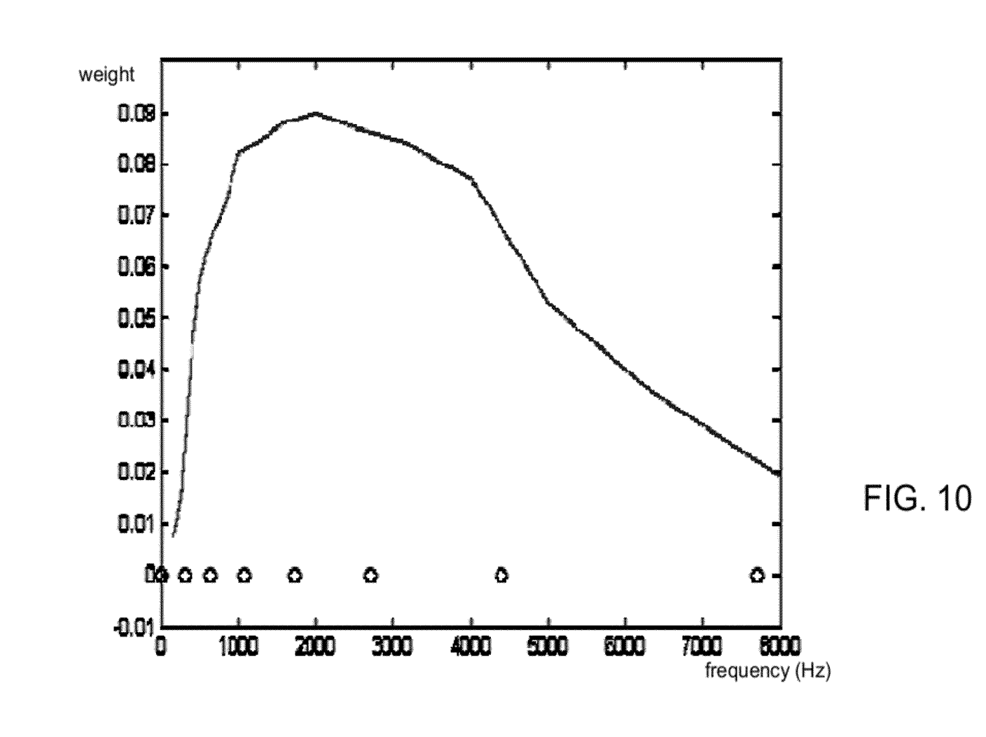

It may be desirable for the filters F10-1 to F10-q to perform a nonuniform subband decomposition of audio signal AS (e.g., such that two or more of the filter passbands have different widths) rather than a uniform subband decomposition (e.g., such that the filter passbands have equal widths). Examples of nonuniform subband division schemes include transcendental schemes, such as a scheme based on the Bark scale, or logarithmic schemes, such as a scheme based on the Mel scale. One such division scheme is illustrated by the dots in FIG. 10, which correspond to the frequencies 20, 300, 630, 1080, 1720, 2700, 4400, and 7700 Hz and indicate the edges of a set of seven Bark scale subbands whose widths increase with frequency. Such an arrangement of subbands may be used in a wideband speech processing system (e.g., a device having a sampling rate of 16 kHz). In other examples of such a division scheme, the lowest subband is omitted to obtain a six-subband scheme and/or the upper limit of the highest subband is increased from 7700 Hz to 8000 Hz.

In a narrowband speech processing system (e.g., a device that has a sampling rate of 8 kHz), it may be desirable to use an arrangement of fewer subbands. One example of such a subband division scheme is the four-band quasi-Bark scheme 300-510 Hz, 510-920 Hz, 920-1480 Hz, and 1480-4000 Hz. Use of a wide high-frequency band (e.g., as in this example) may be desirable because of low subband energy estimation and/or to deal with difficulty in modeling the highest subband with a biquad.

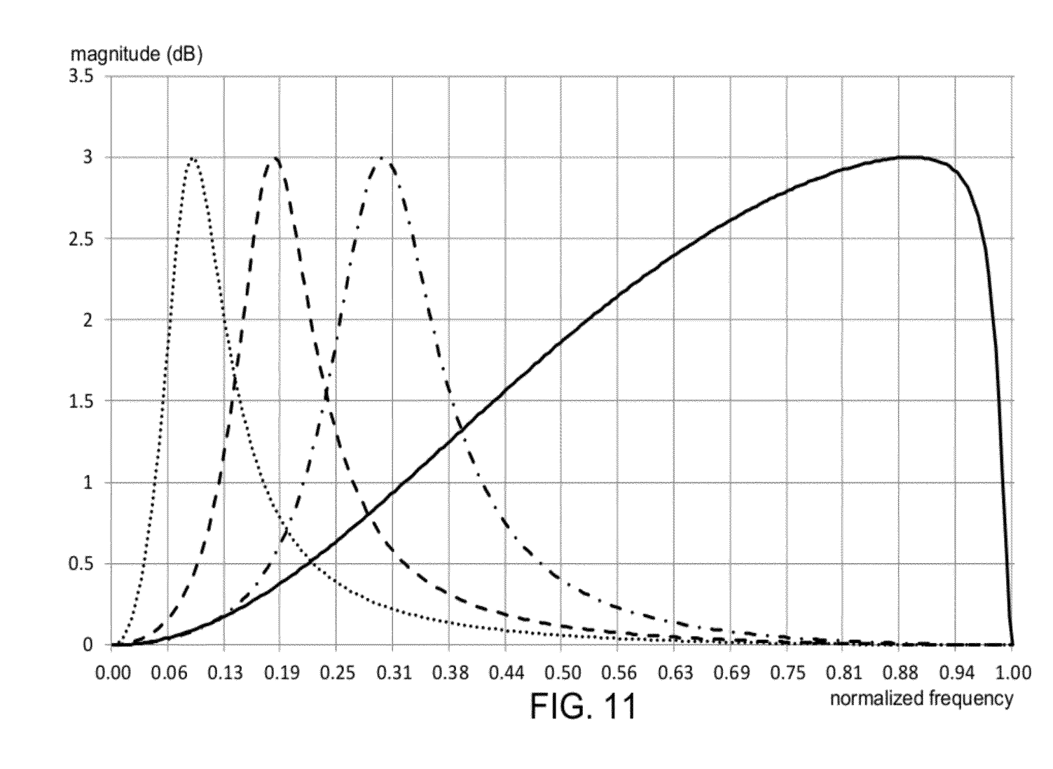

In one example of a four-subband scheme for a narrowband signal with a sampling frequency of 8 kHz, the peak frequency of each filter in Hz is {355, 715, 1200, 3550} and the bandwidth of the passband of each filter in Hz is {310, 410, 560, 1700}. FIG. 11 shows a plot of magnitude responses for such a set of biquad filters. In one example of a six-subband scheme for a wideband signal with a sampling frequency of 16 kHz, the peak frequency of each filter in Hz is {465, 855, 1400, 2210, 3550, 6200} and the bandwidth of the passband of each filter in Hz is {330, 450, 640, 980, 1700, 3600}. In one example of a seven-subband scheme for a superwideband signal with a sampling frequency of 32 kHz, the peak frequency of each filter in Hz is {465, 855, 1400, 2210, 3550, 6200, 11750} and the bandwidth of the passband of each filter in Hz is {330, 450, 640, 980, 1700, 3600, 7500}. This seven-subband scheme may also be used for a fullband signal with a sampling frequency of 48 kHz. Further examples include a seventeen-subband scheme for narrowband and a twenty-three-subband scheme for wideband (e.g., according to the equivalent rectangular bandwidth (ERB) scale), and a four-subband scheme for narrowband and a six-subband scheme for wideband that use third-octave filter banks. Such a wide band structure as in the latter cases may be more suitable for broadband signals, such as speech. In a further example, it may be desirable to increase the number of subbands in accordance with a perceptual scale, such as the Bark scale (e.g., such that the biquad filters may potentially represent auditory filters).

Each of the filters F10-1 to F10-q is configured to provide a gain boost (i.e., an increase in signal magnitude) over the corresponding subband and/or an attenuation (i.e., a decrease in signal magnitude) over the other subbands. Each of the filters may be configured to boost its respective passband by about the same amount (for example, by three dB, or by six dB). Alternatively, each of the filters may be configured to attenuate its respective stopband by about the same amount (for example, by three dB, or by six dB).

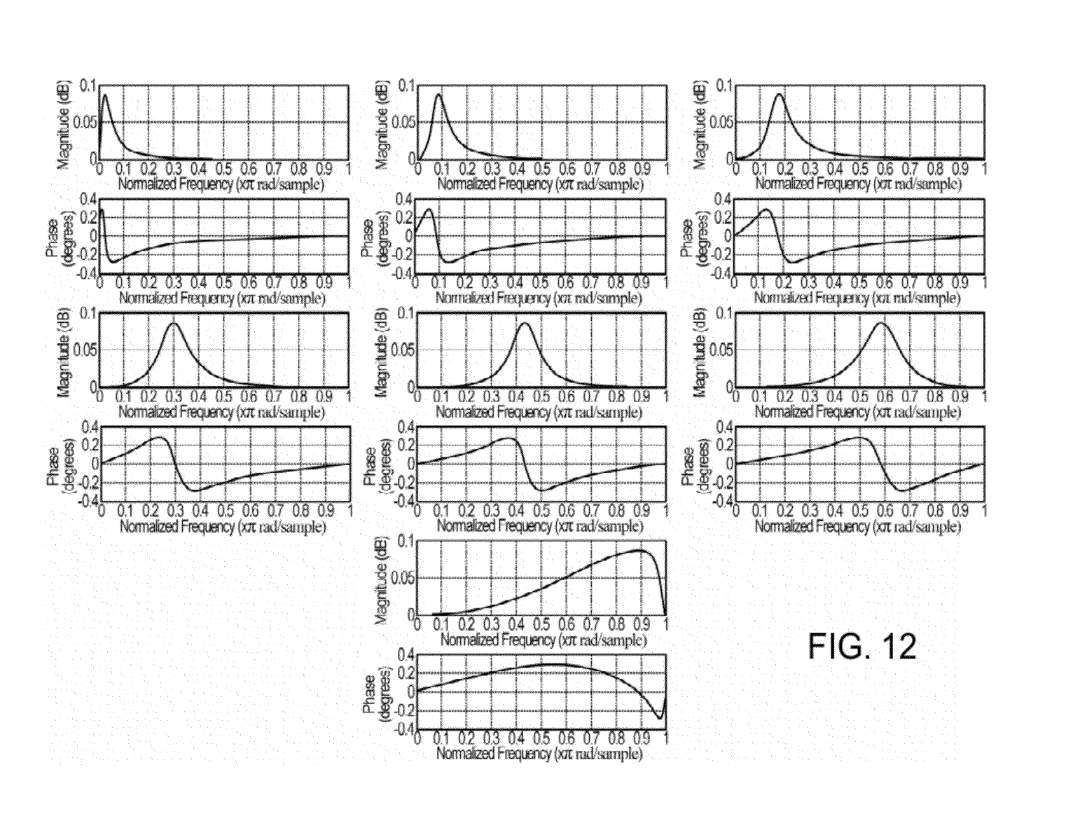

FIG. 12 shows magnitude and phase responses for a series of seven biquads that may be used to implement a set of filters F10-1 to F10-q where q is equal to seven. In this example, each filter is configured to boost its respective subband by about the same amount. Alternatively, it may be desirable to configure one or more of filters F10-1 to F10-q to provide a greater boost (or attenuation) than another of the filters. For example, the peak gain boosts provided by filters F10-1 to F10-q may be selected according to a desired psychoacoustic weighting function.

FIG. 7B shows an arrangement in which the filters F10-1 to F10-q produce the subband signals SB(1) to SB(q) in parallel. One of ordinary skill in the art will understand that each of one or more of these filters may also be implemented to produce two or more of the subband signals serially. For example, analysis filter array AF100 may be implemented to include a filter structure (e.g., a biquad) that is configured at one time with a first set of filter coefficient values to filter audio signal AS to produce one of the subband signals SB(1) to SB(q), and is configured at a subsequent time with a second set of filter coefficient values to filter audio signal AS to produce a different one of the subband signals SB(1) to SB(q). In such case, analysis filter array AF100 may be implemented using fewer than q bandpass filters. For example, it is possible to implement analysis filter array AF100 with a single filter structure that is serially reconfigured in such manner to produce each of the q subband signals SB(1) to SB(q) according to a respective one of q sets of filter coefficient values.

It may be desirable to implement analysis filter array AF100 to scale one or more of the subband signals SB(1) to SB(q) according to response characteristics of the corresponding microphones (e.g., to match the noise subband signals to the sound pressure level actually experienced by the user).

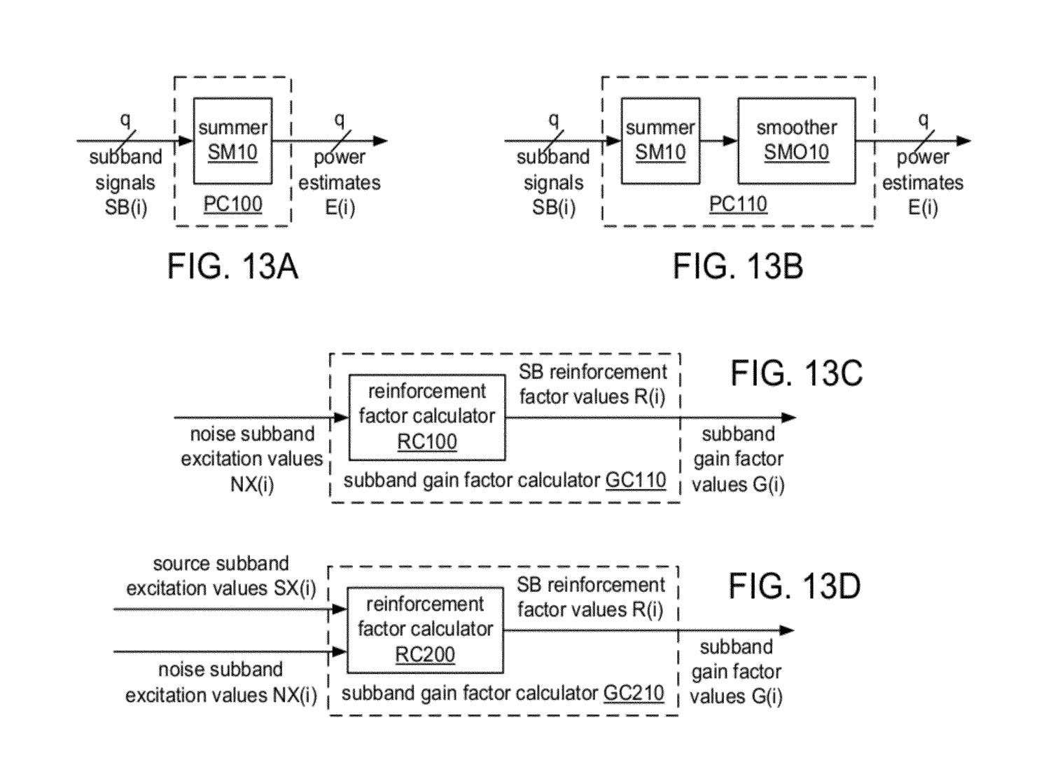

Subband excitation value calculator XC100 may be implemented to produce noise excitation values NX(i) that are based on power estimates of the respective subbands NSB(i). FIG. 13A shows a block diagram of a power estimate calculator PC100 that includes a summer SM10 configured to receive the set of subband signals S(i) and to produce a corresponding set of q subband power estimates E(i), where 1≦i≦q. An instance of any of the implementations of power estimate calculator PC100 as described herein may be used to implement excitation value calculator XC100 such that the subband signals SB(i) correspond to the noise subband signals NSB(i) and the power estimates E(i) correspond to the noise excitation values NX(i).

Subband excitation value calculator XC100 may be implemented to produce a corresponding noise excitation value NX(i) for each of the noise subband signals NSB(i). Alternatively, subband excitation value calculator XC100 may be implemented to produce a number of noise excitation values NX(i) that is fewer than the number of noise subband signals NSB(i) (e.g., such that no excitation value is calculated for each of one or more of the noise subband signals).

Summer SM10 is typically configured to calculate a set of q subband power estimates E(i) for each block of consecutive samples (also called a “frame”) of audio signal AS. Typical frame lengths range from about five or ten milliseconds to about forty or fifty milliseconds, and the frames may be overlapping or nonoverlapping. A frame as processed by one operation may also be a segment (i.e., a “subframe”) of a larger frame as processed by a different operation. In one particular example, audio signal AS is divided into a sequence of ten-millisecond nonoverlapping frames, and summer EC10 is configured to calculate a set of q subband power estimates for each frame of audio signal AS. In another particular example, audio signal AS is divided into a sequence of twenty-millisecond nonoverlapping frames.

Summer SM10 may be implemented to calculate each of the subband power estimates E(i) in the power domain. In such case, summer SM10 may be implemented to calculate each estimate E(i) as an energy of a frame of the corresponding one of the subband signals S(i) (e.g., as a sum of the squares of the time-domain samples of the frame). Such an implementation of summer SM10 may be configured to calculate a set of q subband power estimates for each frame of audio signal AS according to an expression such as

$$E ( i , k ) = {\sum }_{j ∈ k}^{ } {S ( i , j )}^{2} , 1 \leq i \leq q , \qquad ( 2 )$$

where E(i,k) denotes the subband power estimate for subband i and frame k and S(i,j) denotes the j-th sample of the i-th subband signal. For a power-domain implementation of summer SM10, it may be desirable to use a value of 3 dB (or, in the linear domain, the square root of two) for the gain factor g, of each of the biquads of analysis filter array AF100.

In another example, summer SM10 is configured to calculate each of the subband power estimates E(i) in the magnitude domain. In such case, summer SM10 may be implemented to calculate each estimate E(i) as a sum of the magnitudes of the values of the corresponding one of the subband signals S(i). Such an implementation of summer SM10 may be configured to calculate a set of q subband power estimates for each frame of the audio signal according to an expression such as

$$E ( i , k ) = {\sum }_{j ∈ k}^{ } \vert S ( i , j ) \vert , 1 \leq i \leq q . \qquad ( 3 )$$

For a magnitude-domain implementation of summer SM10, it may be desirable to use a value of 6 dB (or, in the linear domain, two) for the gain factor g, of each of the biquads of analysis filter array AF100. Estimation in the power domain may be more accurate, while estimation in the magnitude domain may be less computationally expensive.

It may be desirable to implement summer SM10 to normalize each subband sum by a corresponding sum of audio signal AS. In one such example, summer SM10 is configured to calculate each one of the subband power estimates E(i) as a sum of the squares of the values of the corresponding one of the subband signals S(i), divided by a sum of the squares of the values of audio signal AS. Such an implementation of summer SM10 may be configured to calculate a set of q subband power estimates for each frame of the audio signal according to an expression such as

$$E ( i , k ) = \frac{{\sum }_{j ∈ k}^{ } {S ( i , j )}^{2}}{{\sum }_{j ∈ k}^{ } {A ( j )}^{2}} , 1 \leq i \leq q , \qquad ( 4 a )$$

where A(j) denotes the j-th sample of audio signal AS. In another such example, summer SM10 is configured to calculate each subband power estimate as a sum of the magnitudes of the values of the corresponding one of the subband signals S(i), divided by a sum of the magnitudes of the values of audio signal AS. Such an implementation of summer SM10 may be configured to calculate a set of q subband power estimates for each frame of the audio signal according to an expression such as

$$E ( i , k ) = \frac{{\sum }_{j ∈ k}^{ } \vert S ( i , j ) \vert}{{\sum }_{j ∈ k}^{ } \vert A ( j ) \vert} , 1 \leq i \leq q . \qquad ( 4 b )$$

For cases in which a division operation is used to normalize each subband sum (e.g., as in expressions (4a) and (4b) above), it may be desirable to add a small positive value ρ to the denominator to avoid the possibility of dividing by zero. The value ρ may be the same for all subbands, or a different value of ρ may be used for each of two or more (possibly all) of the subbands (e.g., for tuning and/or weighting purposes). The value (or values) of ρ may be fixed or may be adapted over time (e.g., from one frame to the next).

Alternatively, it may be desirable to implement summer SM10 to normalize each subband sum by subtracting a corresponding sum of audio signal AS. In one such example, summer SM10 is configured to calculate each one of the subband power estimates E(i) as a difference between a sum of the squares of the values of the corresponding one of the subband signals S(i) and a sum of the squares of the values of audio signal AS. Such an implementation of summer SM10 may be configured to calculate a set of q subband power estimates for each frame of the audio signal according to an expression such as

E(i,k)=Σ_{j∈k}S(i,j)²−Σ_{j∈k}A(j)², 1≦i≦q. (5a)

In another such example, summer SM10 is configured to calculate each one of the subband power estimates E(i) as a difference between a sum of the magnitudes of the values of the corresponding one of the subband signals S(i) and a sum of the magnitudes of the values of audio signal AS. Such an implementation of summer SM10 may be configured to calculate a set of q subband power estimates for each frame of the audio signal according to an expression such as

E(i,k)=Σ_{j∈k}|S(i,j)|−Σ_{j∈k}|A(j)|, 1≦i≦q. (5b)

It may be desirable, for example, for an implementation of apparatus A100 to include a boosting implementation of subband filter array FA110 as analysis filter array AF100 and an implementation of summer SM10 that is configured to calculate a set of q subband power estimates according to expression (5b) as excitation value calculator XC100.

Subband power estimate calculator PC100 may be configured to perform a temporal smoothing operation on the subband power estimates. FIG. 13B shows a block diagram of such an implementation PC110 of subband power estimate calculator PC100. Subband power estimate calculator PC110 includes a smoother SMO10 that is configured to smooth the sums calculated by summer SM10 over time to produce the subband power estimates E(i). Smoother SMO10 may be configured to compute the subband power estimates E(i) as running averages of the sums. Such an implementation of smoother SMO10 may be configured to calculate a set of q subband power estimates E(i) for each frame of audio signal AS according to a linear smoothing expression such as one of the following:

E(i, k)←μE(i,k−1)+(1−μ)E(i,k), (6)

E(i, k)←μE(i,k−1)+(1−μ)|E(i,k)|, (7)

E(i, k)←μE(i,k−1)+(1−μ)\sqrt{E(i,k)²}, (8)

for 1≦i≦q, where smoothing factor μ is a value between zero (no smoothing) and 0.9 (maximum smoothing) (e.g., 0.3, 0.5, or 0.7). It may be desirable for smoother SMO10 to use the same value of smoothing factor μ for all of the q subbands. Alternatively, it may be desirable for smoother SMO10 to use a different value of smoothing factor μ for each of two or more (possibly all) of the q subbands. The value (or values) of smoothing factor μ may be fixed or may be adapted over time (e.g., from one frame to the next).

In one particular magnitude-domain example of excitation value calculator XC100 as an instance of calculator PC100, summer SM10 is configured to produce the q subband excitation values NX(i) as subband power estimates E(i) calculated according to expression (3) above. In another particular magnitude-domain example of excitation value calculator XC100 as an instance of calculator PC100, summer SM10 is configured to produce the q subband excitation values NX(i) as subband power estimates E(i) calculated according to expression (5b) above. In another particular magnitude-domain example of excitation value calculator XC100 as an instance of calculator PC110, summer SM10 is configured to calculate the q subband sums according to expression (3) above and smoother SMO10 is configured to produce the q subband excitation values NX(i) as subband power estimates E(i) calculated according to expression (7) above. In a further particular magnitude-domain example of excitation value calculator XC100 as an instance of calculator PC110, summer SM10 is configured to calculate the q subband sums according to expression (5b) above and smoother SMO10 is configured to produce the q subband excitation values NX(i) as subband power estimates E(i) calculated according to expression (7) above.

In one particular power-domain example of excitation value calculator XC100 as an instance of calculator PC100, summer SM10 is configured to produce the q subband excitation values NX(i) as subband power estimates E(i) calculated according to expression (2) above. In another particular power-domain example of excitation value calculator XC100 as an instance of calculator PC100, summer SM10 is configured to produce the q subband excitation values NX(i) as subband power estimates E(i) calculated according to expression (5a) above. In another particular power-domain example of excitation value calculator XC100 as an instance of calculator PC110, summer SM10 is configured to calculate the q subband sums according to expression (2) above and smoother SMO10 is configured to produce the q subband excitation values NX(i) as subband power estimates E(i) calculated according to expression (6) above. In a further particular power-domain example of excitation value calculator XC100 as an instance of calculator PC110, summer SM10 is configured to calculate the q subband sums according to expression (5a) above and smoother SMO10 is configured to produce the q subband excitation values NX(i) as subband power estimates E(i) calculated according to expression (6) above. It is noted, however, that all of the eighteen possible combinations of one of expressions (2)-(5b) with one of expressions (6)-(8) are hereby individually expressly disclosed. An alternative implementation of smoother SMO10 may be configured to perform a nonlinear smoothing operation on sums calculated by summer SM10.

It may be desirable to implement subband excitation value calculator XC100 to scale one or more of the power estimates E(i) or excitation values X(i) according to response characteristics of the corresponding microphones (e.g., to match the noise subband excitation values to the sound pressure level actually experienced by the user).

Subband gain factor calculator GC100 may be implemented to include a reinforcement factor calculator RC100. Reinforcement factor calculator RC100 is configured to calculate subband reinforcement factors R(i) that are based on the noise subband excitation values NX(i). FIG. 13C shows a block diagram of such an implementation GC110 of subband gain factor calculator GC100 that is configured to output the subband reinforcement factors R(i) as subband gain factors G(i). Calculating the reinforcement factor R(i) includes raising a value that is based on the noise subband excitation value NX(i) to a power of α, where α is a compressive exponent (i.e., has a value between zero and one). In one example, the value of α is equal to 0.3. In another example, the value of α is equal to 0.2.

Reinforcement factor calculator RC100 may be configured to calculate, for each of the noise subband excitation values NX(i), a corresponding subband reinforcement factor R(i) that is based on the noise subband excitation value NX(i). Alternatively, reinforcement factor calculator RC100 may be implemented to produce a number of subband reinforcement factors R(i) that is fewer than the number of noise excitation values NX(i) (e.g., such that no reinforcement factor is calculated for each of one or more of the noise excitation values).

Reinforcement factor calculator RC100 may be configured to calculate the reinforcement factor R(i) as a compressed value v_{N}(i) that is based on the noise excitation value NX(i). In one example, reinforcement factor calculator RC100 produces the compressed value v_{N}(i) as a noise loudness value L_{N}(i). Such an implementation of calculator RC100 may be configured to produce noise loudness value L_{N}(i) for frame k according to a model such as one of the following:

L_{N}(i,k)=f([NX(i,k)]^{α}); 1)

L_{N}(i,k)=f([p_{N}(i)NX(i,k)+q_{N}(i)]^{α}); 2)

L_{N}(i,k)=f([p_{N}(i)NX(i,k)+p_{TH}(i)TX(i)+q_{N}(i)[^{α}); 3)

L_{N}(i,k)=f([p_{N}(i)NX(i,k)+q_{N}(i)]^{α}, [p_{TH}(i)TX(i)+q_{TH}(i)]^{α}); 4)

where TX(i) is a threshold excitation value of hearing in quiet for subband i; p_{N}(i) and P_{TH}(i) are weighting factors for subband noise excitation value NX(i) and subband threshold excitation value TX(i), respectively; and q_{N}(i) and q_{TH}(i) are weighting terms for NX(i) and TX(i), respectively. In one example, TX(i) has the values {28, 25, 19, 16, 8, 5.5, 4, 3.5, 3.5} (in dB) at the frequencies {50, 100, 800, 1000, 2000, 3000, 4000, 5000, 10,000} (in Hz) (e.g., see FIG. 4 of Moore et al., “A model for the prediction of thresholds, loudness, and partial loudness,” J. Audio Eng. Soc., vol. 45, no. 4, pp. 224-240, April 1997). In another example, TX(i) has the values {79, 53, 34, 20, 10, 3, 1, 3, −3, 15} (in dB) at the frequencies { 16, 32, 63, 125, 250, 500, 1000, 2000, 4000, 8000} (in Hz).

Some particular expressions of these perceptual models for noise loudness value L_{N}(i) include the following, where C is a scaling factor:

L_{N}(i,k)=C[NX(i)]^{α};

L_{N}(i,k)=C[NX(i,k)−TX(i)]^{α} (i.e., p_{N}(i)=1, p_{TH}(i)=−1, q(i)=0∀i);

L_{N}(i,k)=C([NX(i,k)^{α}]−[TX(i)^{α}]);

L_{N}(i,k)=C([NX(i,k)+q_{1TH}TX(i)]^{α}−[q_{2TH}TX(i)]^{α}),

where q_{1TH}(i) and q_{2TH}(i) are weighting terms for TX(i). The noise loudness value L_{N}(i) may be mapped to a value of reinforcement factor R(i) according to a fixed mapping, such as R(i,k)=m(i)L_{N}(i,k), where m(i) is a mapping factor that may differ from one subband to another.

It may be desirable to implement subband gain factor calculator GC100 to calculate subband gain factors G(i) based on information from reproduced audio signal RAS10. For example, subband gain factor calculator GC100 may be implemented to calculate each subband gain factor G(i) based on a corresponding source subband excitation value SX(i).

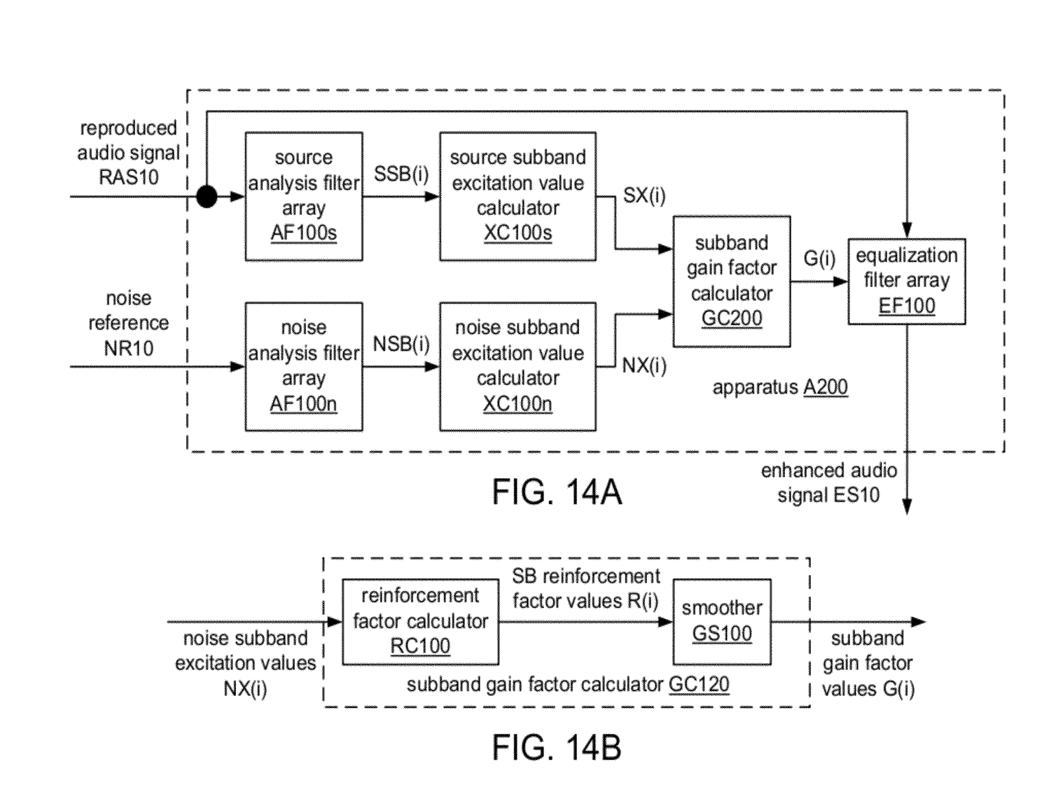

FIG. 14A shows a block diagram of such an implementation A200 of apparatus A100. In addition to an instance AF100n of analysis filter array AF100 that is configured to produce noise subband signals NSB(i) as described herein, apparatus A200 includes an instance AF100s of analysis filter array AF100 that is configured to produce source subband signals SSB(i). An instance of any of the implementations of subband filter array FA110 as described herein may be used to implement source analysis filter array AF100s such that audio signal AS corresponds to reproduced audio signal RAS10 and the subband signals SB(1) to SB(q) correspond to the source subband signals SSB(i). For example, it may be desirable to implement source analysis filter array AF100s as an instance of the same implementation of subband filter array FA110 as noise analysis filter array AF100n. It is also possible to implement source analysis filter array AF100s and noise analysis filter array AF100n as the same instance of subband filter array FA110 (i.e., at different times).

In addition to an instance XC100n of subband excitation value calculator XC100 that is configured to produce noise excitation values NX(i) as described herein, apparatus A200 includes an instance XC100s of subband excitation value calculator XC100 that is configured to produce source excitation values SX(i). An instance of any of the implementations of subband excitation value calculator XC100 as described herein may be used to implement source subband excitation value calculator XC100s such that the subband signals SB(i) correspond to the source subband signals SSB(i) and the power estimates E(i) correspond to the source excitation values SX(i). For example, it may be desirable to implement source subband excitation value calculator XC100s as an instance of the same implementation of subband excitation value calculator XC100 as noise subband excitation value calculator XC100n. It is also possible to implement source subband excitation value calculator XC100s and noise subband excitation value calculator XC100n as the same instance of subband excitation value calculator XC100 (i.e., at different times).

In one particular example, apparatus A200 is configured to calculate the source and noise subband excitation values as power estimates in the magnitude domain (e.g., according to expression (5b)) using biquads with band gain of 2.0. In another particular example, apparatus A200 is configured to calculate the source and noise subband excitation values as power estimates in the power domain (e.g., according to expression (5a)) using biquads with band gain of 3 dB, or the square root of two in the linear domain.

Apparatus A200 includes an implementation GC200 of subband gain factor calculator GC100 that is configured to calculate each subband gain factor G(i) based on the corresponding noise subband excitation value NX(i) and the corresponding source subband excitation value SX(i). FIG. 13D shows a block diagram of an implementation GC210 of subband gain factor calculator GC200 that includes an implementation RC200 of reinforcement factor calculator RC100. Reinforcement factor calculator RC200 is configured to calculate, for each of the noise subband excitation values NX(i), a corresponding subband reinforcement factor R(i) that is based on the noise subband excitation value NX(i) and the corresponding source subband excitation value SX(i). In this example, subband gain factor calculator GC210 is configured to output the subband reinforcement factors R(i) as subband gain factors G(i).

It may be desirable for the mapping of the noise loudness value L_{N}(i) to a value of reinforcement factor R(i) to be dependent upon a level of reproduced audio signal RAS10 in the subband. For example, reinforcement factor calculator RC200 may be configured to calculate a value of reinforcement factor R(i) for frame k according to an expression such as R(i,k)=m(i)L_{N}(i,k)/SX(i,k), where SX(i,k) is the source excitation value for subband i and frame k, or R(i,k)=m(i)L_{N}(i,k)/L_{S}(i,k), where L_{S}(i,k) is a source loudness value for subband i and frame k.

In another example, reinforcement factor calculator RC200 is configured to produce the compressed value v_{N}(i) based on both the noise excitation value NX(i) and the source excitation value SX(i) and to produce reinforcement factor R(i) based on value v_{N}(i). In a further example, reinforcement factor calculator RC200 is configured to produce reinforcement factor R(i) also based on another compressed value v_{S}(i) which is based on source subband excitation value SX(i). In another example, reinforcement factor calculator RC200 is configured to produce reinforcement factor R(i) also based on hearing threshold excitation value TX(i) (e.g., based on a compressed value v_{T}(i) that is based on TX(i)).

In a particular example, reinforcement factor calculator RC200 is configured to produce the reinforcement factors R(i) as a nonlinear function of the corresponding noise excitation value NX(i) and source excitation value SX(i), according to an expression such as the following:

$$R ( i , k ) {( \frac{\frac{{( {v}_{S} ( i , k ) + {v}_{N} ( i , k ) - {v}_{T} ( i ) )}^{1 / α} - A}{C} - NX ( i , k )}{SX ( i , k )} )}^{1 / 2} , \qquad ( 9 )$$

where the compressed values v_{S}(i), v_{N}(i), and v_{T}(i) may be expressed as follows:

v_{S}(i,k)=(C[SX(i,k)]+A)^{α};

v_{N}(i,k)=(C(1+K)NX(i,k)+C[TX(i)]+A)^{α};

v_{T}(i)=(C[TX(i)]+A)^{α}.

Expression (9) is based on mathematical representations of specific loudness in quiet and of partial specific loudness (i.e., loudness in the presence of another signal) that are described in greater detail in Shin et al. and Moore et al. as cited herein. The underlying model may be expressed as

N′_{Q}(SX(i))=N′ₚₐᵣₜᵢₐₗ(R(i,k)²SX(i),NX(i)),

where N′_{Q}(SX(i)) denotes specific loudness in quiet as a function of SX(i) and

N′ₚₐᵣₜᵢₐₗ(R(i,k)²SX(i),NX(i))

denotes partial specific loudness as a function of R(i,k), SX(i), and NX(i). It may be expected that applying such a reinforcement factor R(i) as a gain factor to subband i of reproduced audio signal RAS10 will produce, in the presence of the near-end noise as indicated by noise reference NR10, a partial specific loudness in the subband that is the same as the specific loudness of the noise-free signal RAS10 in the subband.

In expression (9), the value of A may be equal to 2[TX(i)]. In one example, the parameter K has the values {13.3, 5, −1, −2, −3, −3} (in dB) at the frequencies {50, 100, 300, 400, 1000, 10,000} (in Hz) (e.g., see FIG. 9 of Moore et al.). The parameter C represents the low-level gain of the cochlear amplifier at a specific frequency, relative to the gain at 500 Hz and above. Relationships between the values of C and α, and between the values of C and A, are shown in FIGS. 6 and 7, respectively, of Moore et al. (where C is indicated with the label G), and the product of C and TX(i) may be assumed to be constant.

It may be expected that a gain factor obtained according to expression (9) may become excessive when SX(i,k)>>TN(i,k), where TN(i,k)=C[NX(i,k)]+TX(i). It may be desirable to configure reinforcement factor calculator GC200 to shrink R(i) when such a condition occurs. One example of such a shrinking rule may be expressed as follows: R(i,k)²=λR(i,k)²+(1−λ)×1.0 if R(i,k)²SX(i,k)>TN(i,k)×128, where λ=TN(i,k)×128/[R(i,k)²SX(i,k)].

The use of exact parameter values for the compressive exponent α may lead to a computational load that is too heavy for a desired application. It may be desirable instead to use a constant value (e.g., 0.2) of α for frequencies higher than 500 Hz. For the narrowband (e.g., four-band) and wideband (e.g., six-band) implementations as described above, for example, a value for α of 0.203 and 0.201, respectively, may be used for the first (lowest-frequency) subband, with a value for α of 0.2 being used for the other subbands.

Alternatively, it may be desirable to approximate all the values for α by a constant value (e.g., 0.2). Without changing other parameters, this approximation may result in an equalization output that is somewhat muffled in cases of very low SNR. Consequently, it may be desirable to change the values of one or more other model parameters (e.g., K, TX(i), C, and/or A) accordingly to fit the gain function with the original parameter values.

As described herein, it may be desirable to implement subband gain calculator GC100 (e.g., reinforcement factor calculator RC100) to apply a loudness perception model that is based on a response of a human auditory filter (e.g., as in expression (9)). Such response is typically expressed in terms of equivalent rectangular bandwidth (ERB) of the auditory filter. For example, the quantities “specific loudness” and “partial specific loudness” are typically expressed in terms of ERB. Although warping of the frequency to the ERB scale may be performed inherently by a corresponding biquad filter of analysis filter array AF100, it may be desirable to configure subband excitation value calculator XC100 (e.g., calculators XC100s and/or XC100n) to fit one or more (possibly all) of the subband power estimates to the loudness perception model by compensating for a difference between the subband filter bandwidth and the bandwidth of a corresponding human auditory filter (e.g., as represented by the ERB).

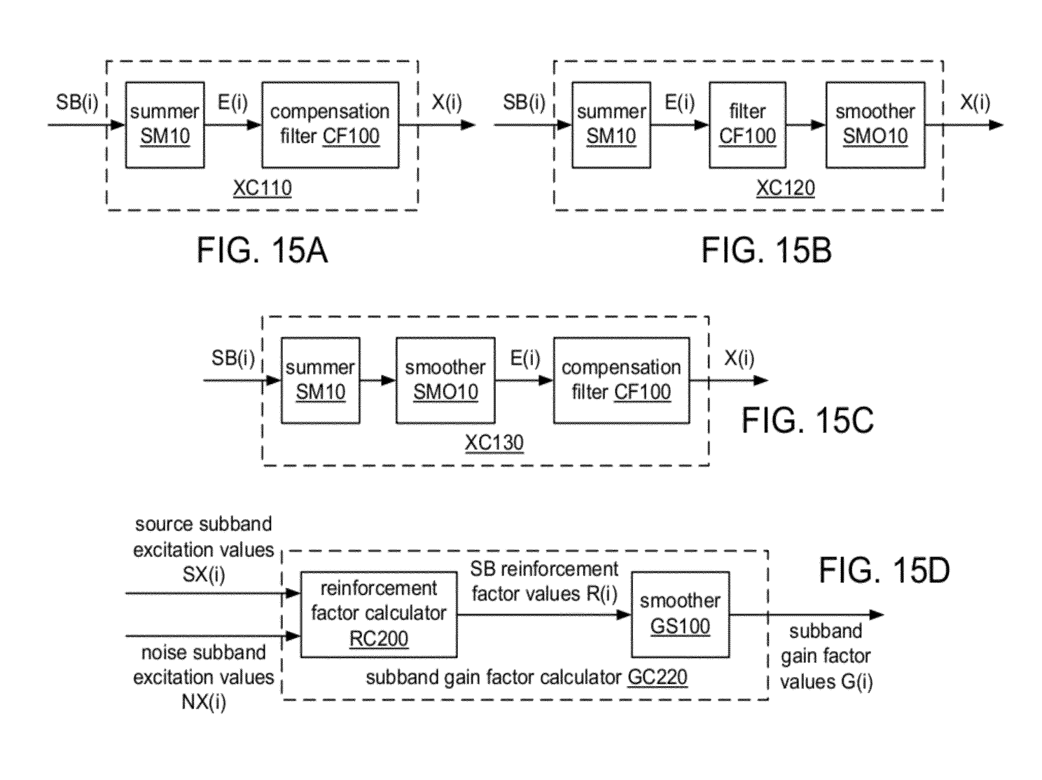

FIG. 15A shows a block diagram of an implementation XC110 of subband excitation value calculator XC100 that includes a compensation filter CF100. FIGS. 15B and 15C show block diagram of similar implementations XC120 and XC130, respectively, of subband excitation value calculator XC110. Compensation filter CF100 is configured to scale the power estimates E(i) according to a relation between the bandwidth of the corresponding subband analysis filter and an equivalent rectangular bandwidth. In one example, compensation filter CF100 is implemented to multiply a power estimate E(i) by a corresponding bandwidth compensation factor that is equal to ERB(i)/BW(i), where BW(i) is the width of the passband of the corresponding subband filter of analysis filter array AF100 and ERB(i) is the ERB of an auditory filter whose center frequency is the same as the peak frequency of the subband filter.

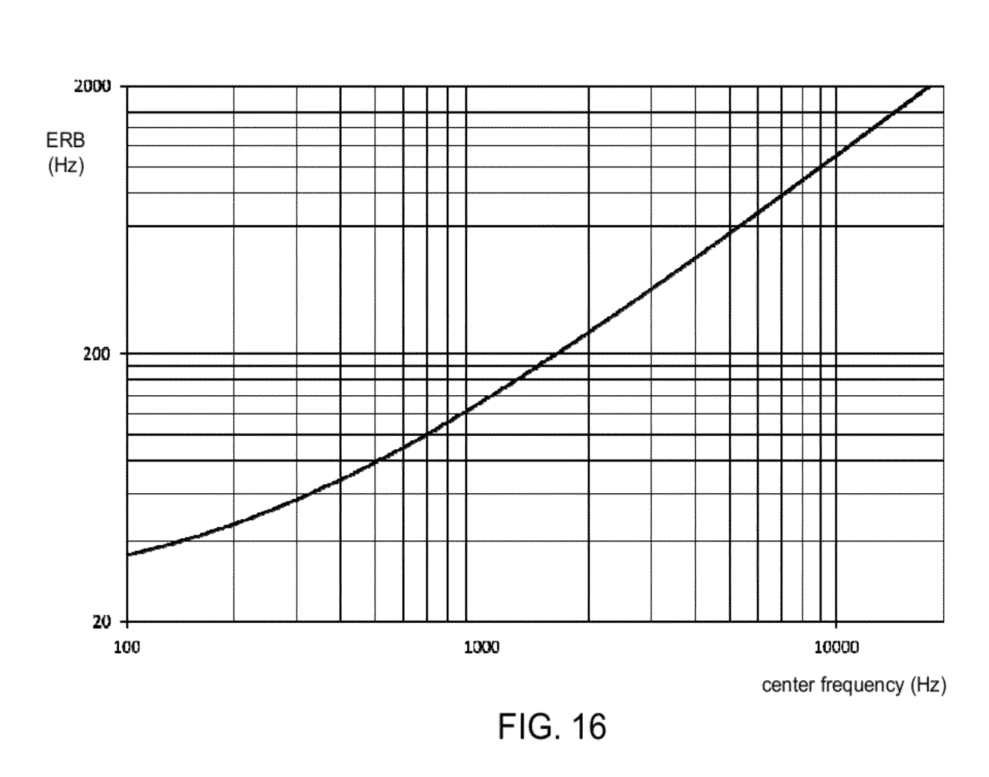

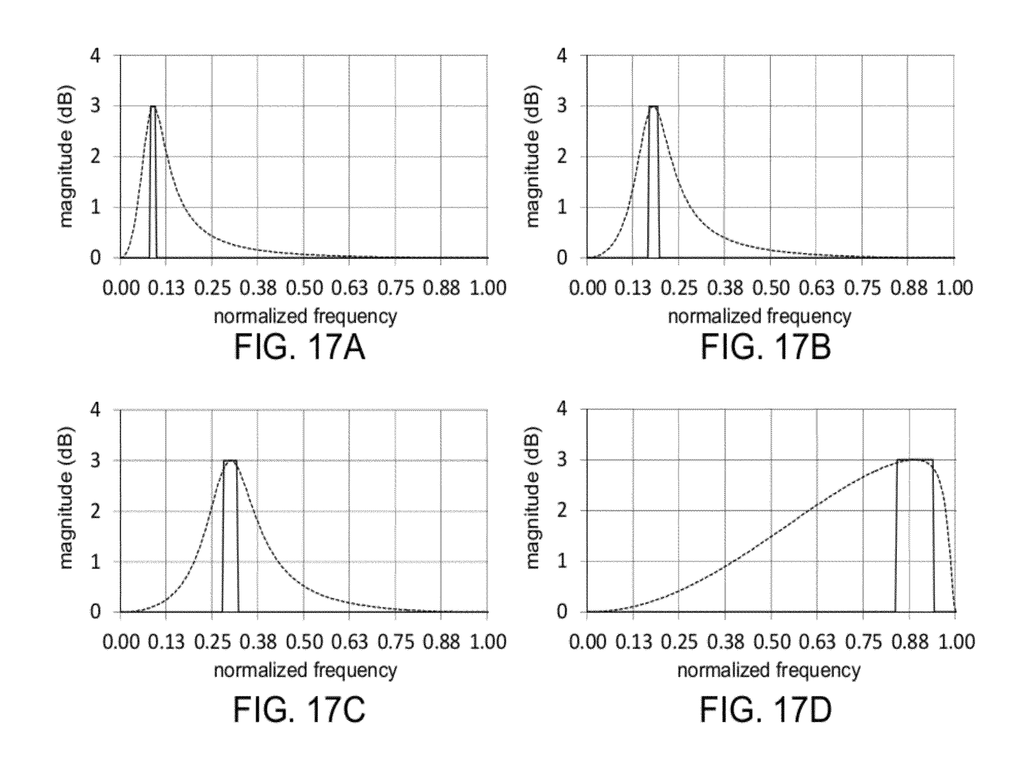

At moderate sound pressure levels, the ERB of an auditory filter (in Hz) may be expressed in terms of the center frequency F of the auditory filter (in kHz) as ERB=24.7(4.37F+1). FIG. 16 shows a plot of ERB in Hz vs. center frequency for a human auditory filter, and FIGS. 17A-17D show the magnitude responses for the biquads of a four-subband narrowband scheme as described above (e.g., in which the peak frequency of each filter in Hz is {355, 715, 1200, 3550} and the bandwidth of the passband of each filter in Hz is {310, 410, 560, 1700}) and the corresponding ERBs. It is expressly noted that each of noise subband excitation value calculator XC100n and source subband excitation value calculator XC100s may be implemented as an instance of any of subband excitation value calculators XC110, XC120, and XC130.

Equalization filter array EF100 is configured to apply the subband gain factors to corresponding subbands of reproduced audio signal RAS10 to produce enhanced audio signal ES10. Equalization filter array EF100 may be implemented to include an array of bandpass filters, each configured to apply a respective one of the subband gain factors to a corresponding subband of reproduced audio signal RAS10. The filters of such an array may be arranged in parallel and/or in serial. It may be desirable to implement equalization filter array EF100 as an array of subband amplification filters with adaptive subband gains (i.e., as indicated by subband gain factors G(i)).

Equalization filter array EF100 may be configured to apply each of the subband gain factors to a corresponding subband of reproduced audio signal RAS10 to produce enhanced audio signal ES10. Alternatively, equalization filter array EF100 may be implemented to apply fewer than all of the subband gain factors to corresponding subbands.

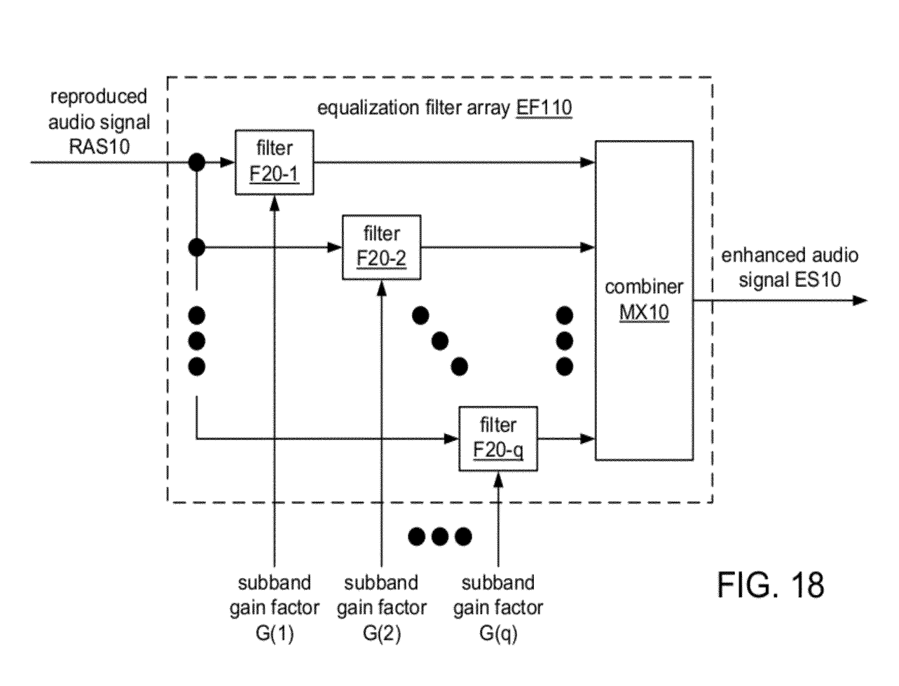

FIG. 18 shows a block diagram of an implementation EF110 of equalization filter array EF100 that includes a set of q bandpass filters F20-1 to F20-q arranged in parallel. In this case, each of the filters F20-1 to F20-q is arranged to apply a corresponding one of q subband gain factors G(1) to G(q) (e.g., as calculated by subband gain factor calculator GC100) to a corresponding subband of reproduced audio signal RAS10 by filtering reproduced audio signal RAS10 according to the gain factor to produce a corresponding bandpass signal. Equalization filter array EF110 also includes a combiner MX10 that is configured to mix the q bandpass signals to produce enhanced audio signal ES10.

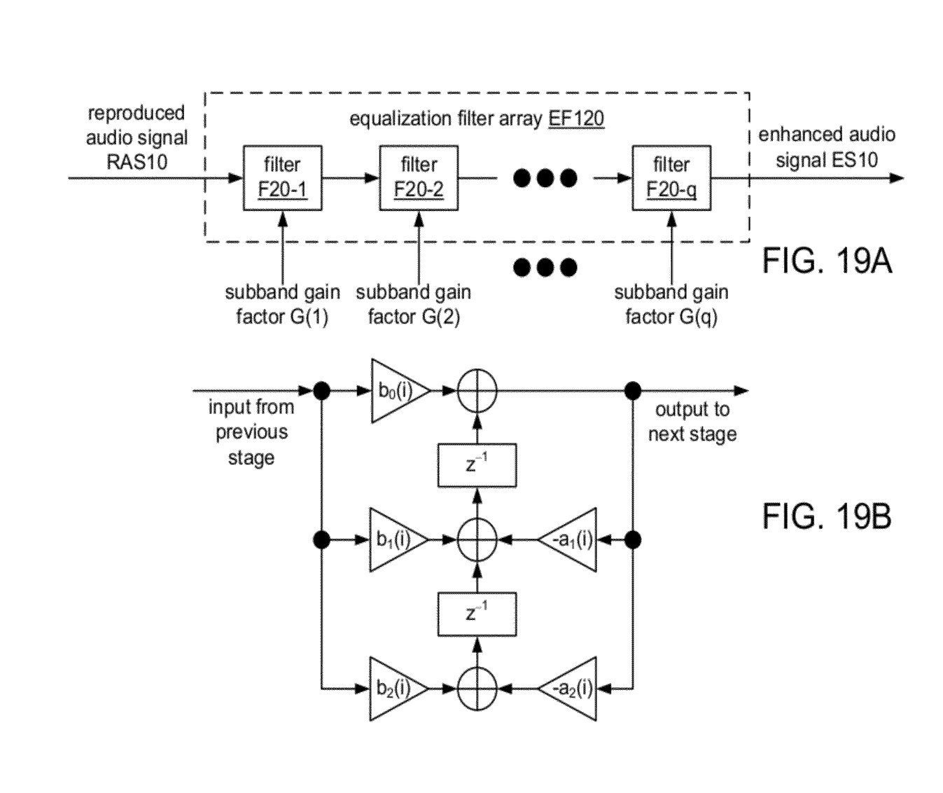

FIG. 19A shows a block diagram of another implementation EF120 of equalization filter array EF100 in which the bandpass filters F20-1 to F20-q are arranged to apply each of the subband gain factors G(1) to G(q) to a corresponding subband of reproduced audio signal RAS10 by filtering reproduced audio signal RAS10 according to the subband gain factors in serial (i.e., in a cascade, such that each filter F20-k is arranged to filter the output of filter F20-(k-1) for 2≦k≦q).

Each of the filters F20-1 to F20-q may be implemented to have a finite impulse response (FIR) or an infinite impulse response (IIR). For example, each of one or more (possibly all) of filters F20-1 to F20-q may be implemented as a biquad. Equalization filter array EF120 may be implemented, for example, as a cascade of biquads. Such an implementation may also be referred to as a biquad IIR filter cascade, a cascade of second-order IIR sections or filters, or a series of subband IIR biquads in cascade. It may be desirable to implement each biquad using the transposed direct form II, especially for floating-point implementations of apparatus A100. FIG. 19B shows a block diagram of such an implementation of one of filters F20-1 to F20-q as a corresponding stage in a cascade of biquads.

Each of the subband gain factors G(1) to G(q) may be used to update one or more filter coefficient values of a corresponding one of filters F20-1 to F20-q. In such case, it may be desirable to configure each of one or more (possibly all) of the filters F20-1 to F20-q such that its frequency characteristics (e.g., the center frequency and width of its passband) are fixed and its gain is variable. Such a technique may be implemented for an FIR or IIR filter by varying only the values of one or more of the feedforward coefficients (e.g., the coefficients b₀, b₁, and b₂ in biquad expression (1) above). In one example, the gain of a biquad implementation of one F20-i of filters F20-1 to F20-q is varied by adding an offset g to the feedforward coefficient b₀ and subtracting the same offset g from the feedforward coefficient b₂ to obtain the following transfer function:

$${H}_{i} ( z ) = \frac{( {b}_{0} ( i ) + g ) + {b}_{1} ( i ) {z}^{- 1} + ( {b}_{2} ( i ) - g ) {z}^{- 2}}{1 + {a}_{1} ( i ) {z}^{- 1} + {a}_{2} ( i ) {z}^{- 2}} . \qquad ( 10 )$$

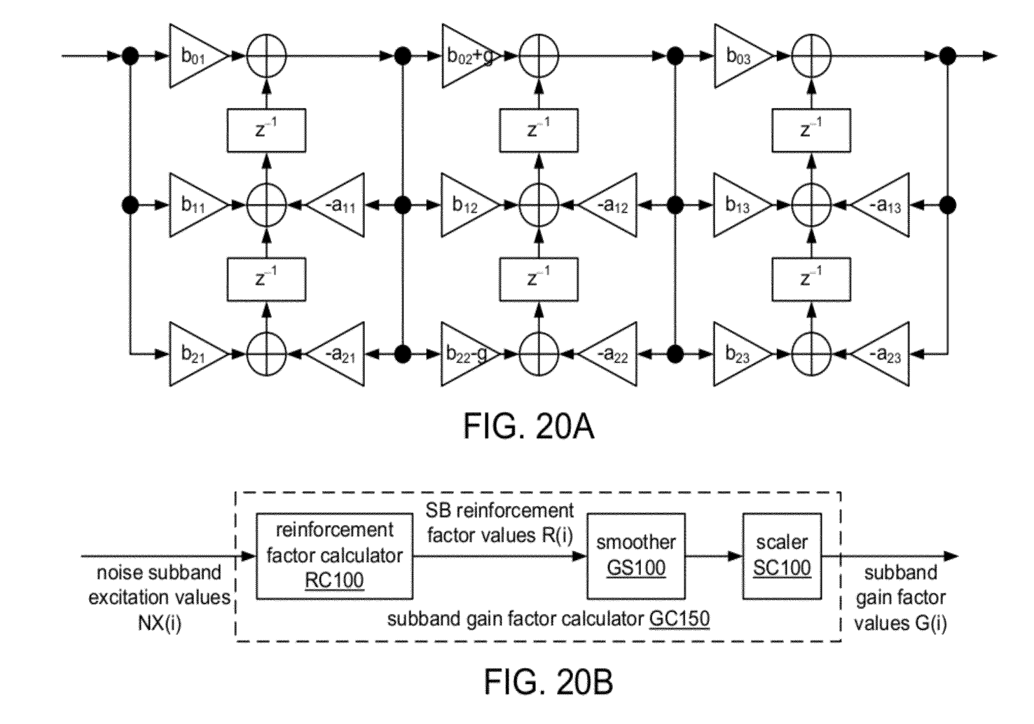

In this example, the values of a₁ and a₂ are selected to define the desired band, the values of a₂ and b₂ are equal, and b₀ is equal to one. The offset g may be calculated from the corresponding gain factor G(i) according to an expression such as g=(1−a₂(i))(G(i)−1)c, where c is a normalization factor having a value less than one which may be tuned such that the desired gain is achieved at the center of the band. FIG. 20A shows such an example of a three-stage cascade of biquads, in which an offset g is being applied to the second stage.

Equalization filter array EF100 may be implemented according to any of the examples of subband division schemes described above with reference to subband filter array FA110 (e.g., four-subband narrowband or six-subband wideband). For example, it may be desirable for the passbands of filters F20-1 to F20-q to represent a division of the bandwidth of reproduced audio signal RAS10 into a set of nonuniform subbands (e.g., such that two or more of the filter passbands have different widths) rather than a set of uniform subbands (e.g., such that the filter passbands have equal widths).

It may be desirable for equalization filter array EF100 to apply the same subband division scheme as an implementation of analysis filter array AF100 (e.g., AF100n and/or AF100s). For example, it may be desirable for equalization filter array EF100 to use a set of filters having the same design as those of such an array or arrays (e.g., a set of biquads), with fixed values being used for the gain factors of the analysis filter array or arrays. Equalization filter array EF100 may even be implemented using the same component filters as such an analysis filter array or arrays (e.g., at different times, with different gain factor values, and possibly with the component filters being differently arranged, as in the cascade of array EF120).

It may be desirable to configure apparatus A100 to pass one or more subbands of reproduced audio signal RAS10 without boosting. For example, boosting of a low-frequency subband may lead to muffling of other subbands, and it may be desirable for apparatus A100 to pass one or more low-frequency subbands of reproduced audio signal RAS10 (e.g., a subband that includes frequencies less than 300 Hz) without boosting.

It may be desirable to design equalization filter array EF100 according to stability and/or quantization noise considerations. As noted above, for example, equalization filter array EF120 may be implemented as a cascade of second-order sections. Use of a transposed direct form II biquad structure to implement such a section may help to minimize round-off noise and/or to obtain robust coefficient/frequency sensitivities within the section. Apparatus A100 may be configured to perform scaling of filter input and/or coefficient values, which may help to avoid overflow conditions. Apparatus A100 may be configured to perform a sanity check operation that resets the history of one or more IIR filters of equalization filter array EF100 in case of a large discrepancy between filter input and output. Apparatus A100 may include one or more modules for quantization noise compensation as well (e.g., a module configured to perform a dithering operation on the output of each of one or more filters of equalization filter array EF100).

Apparatus A100 (e.g., A200) may be configured to include an automatic gain control (AGC) module that is arranged to compress the dynamic range of reproduced audio signal RAS10 before equalization. Such a module may be configured to provide a headroom definition and/or a master volume setting (e.g., to control upper and/or lower bounds of the subband gain factors). Alternatively or additionally, apparatus A100 (e.g., A200) may be configured to include a peak limiter arranged to limit the level of enhanced audio signal ES10.

An LP-based equalization scheme as described herein may be dependent on the level of reproduced audio signal RAS10, such that it may be desirable for apparatus A100 to use different parameter levels for headset, handset, and speakerphone modes.

Headroom control may be used to limit equalization gains. Parameters relevant to headroom control may include maximum gain and maximum output value. For example, apparatus A100 (e.g., A200) may be implemented such that the maximum value of reinforcement factor R(i) or subband gain factor G(i) for a frame is restricted according to the power of reproduced audio signal RAS10 for the frame. In this case, the maximum gain parameter can be relaxed to provide a headroom for the maximum squarewave. It may be desirable to design such headroom control according to interactions of apparatus A100 with other modules involved in the production of reproduced audio signal RAS10 and/or the reproduction of enhanced audio signal ES10.

Other gain-related options may include a minimum value of reinforcement factor R(i) or subband gain factor G(i) (e.g., 1.0); a spectral gain smoothing factor for smoothing values of reinforcement factor R(i) or subband gain factor G(i) for adjacent subbands; and a gain shrink factor.

Especially for a case in which the number of subbands is large (e.g., seventeen subbands for narrowband or twenty-three bands for wideband), it may be desirable to implement apparatus A100 to apply a loudness perception model to fewer than all of the subbands. For example, it may be desirable to implement reinforcement factor calculator RC100 or RC200 to calculate compressed values for fewer than all of the subbands. In such case, it may be desirable to select the frequency range for which the compressed values are calculated. This range may be indicated, for example, by indices of the subbands at the lower and/or upper bounds of the range. It may be desirable to calculate gain factors G(i) for one or more of the subbands outside this range. For example, reinforcement factor calculator RC100 or RC200 may be implemented to calculate reinforcement factors R(i) for subbands higher than the upper bound according to an expression such as R(i)=1.0+(R(u)−1.0)[k(i−u)], where u denotes the upper-bound subband and k is a vector of subband gain expansion factors.

It may be desirable to implement apparatus A100 (e.g., A200) to perform a temporal smoothing operation on the reinforcement factor R(i) to produce the corresponding gain factor G(i). Gain smoothing may be important for preventing distortion (e.g., for a case in which equalization filter array EF100 is implemented as a biquad cascade structure). Rapid change in a filter parameter may introduce artifacts, as the filter memory from the previous filter is used for the current filter. On the other hand, too much smoothing can weaken the effect of equalization for nonstationary noises and speech onset regions.

FIG. 14B shows a block diagram of such an implementation GC120 of subband gain factor calculator GC110. Calculator GC120 includes a smoother GS100 that smoothes the reinforcement factor R(i) to produce a smoothed value. For example, smoother GS100 may be implemented to perform such smoothing according to an first-order IIR expression such as G(i,k)←ηG(i,k−1)+(1−η)R(i,k), where η is a temporal gain smoothing factor having a default value of, for example, 0.9375. In this implementation, gain factor calculator GC120 produces the smoothed value as subband gain factor G(i). FIG. 15D shows a block diagram of a corresponding implementation GC220 of subband gain factor calculator GC210.

It may be desirable to implement smoother GS100 to limit the maximum value of subband gain factor G(i) for the current frame k. Additionally, it may be desirable to implement smoother GS100 to include another parameter which limits the maximum value of the subband gain that is used as a subband gain of the previous frame for smoothing. In general, the value of such a parameter may be smaller than the maximum gain for the current frame. Such a parameter may permit high subband gain while preventing too much propagation of a high subband gain factor value. The following pseudocode listing illustrates one example of implementing such a parameter:

if (G(i,k)>maxGain)G(i,k)=maxGain;

G(i,k−1)=G(i,k);

if (G(i,k−1)>MaxPrevGain)G(i,k−1)=MaxPrevGain;

An equalization scheme may be configured to keep the band gains during periods in which reproduced audio signal RAS10 is inactive. However, this strategy may result in sub-optimal performance when the noise characteristic changes during a receive-inactive period and/or excessive amplification of idle channel noise. It may be desirable to implement apparatus A100 (e.g., A200) to set reinforcement factor R(i) and/or gain factor G(i) to a default value in response to a detection of inactivity of reproduced audio signal RAS10. For example, it may be desirable to implement apparatus A100 (e.g., A200) to set reinforcement factor R(i) to 1.0 for frames in which reproduced audio signal RAS10 does not contain audible sound.

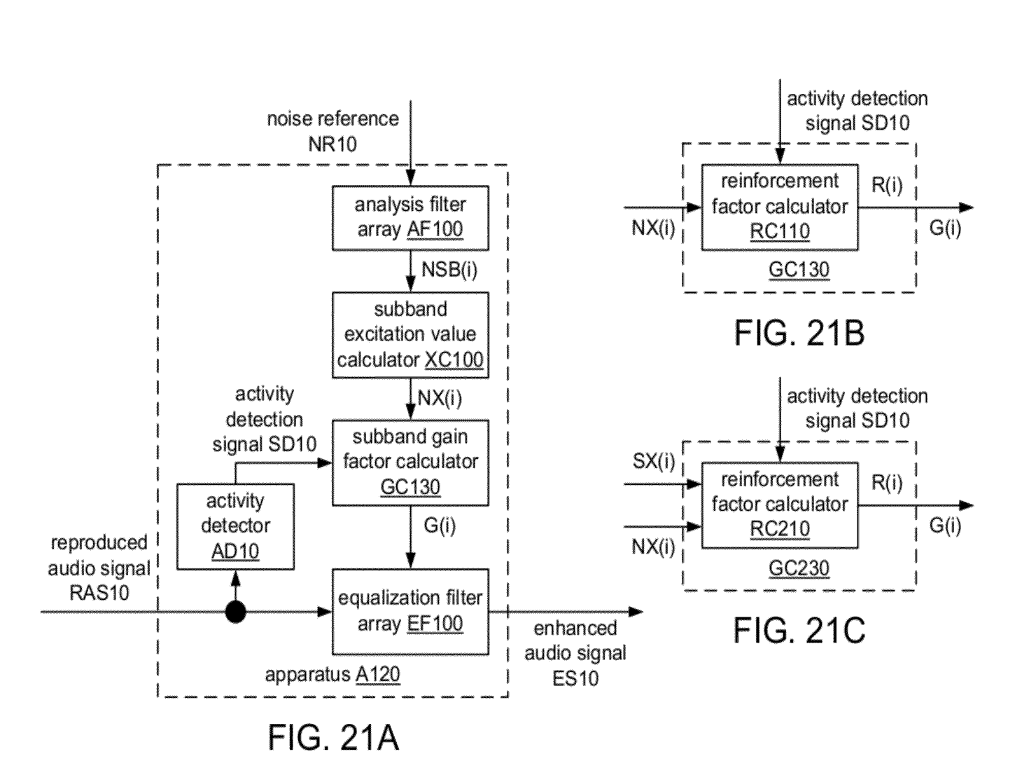

FIG. 21A shows a block diagram of an implementation A120 of apparatus A100 that includes an activity detector AD10 and an implementation GC130 of subband gain factor calculator GC110. Activity detector AD10 produces an activity detection signal SD10 that indicates whether reproduced audio signal RAS10 is active. For example, activity detector AD10 may be implemented to produce activity detection signal SD10 by comparing a current frame energy of reproduced audio signal RAS10 to a threshold value and/or to a corresponding noise reference (e.g., a time-average of inactive frames of signal RAS10). Alternatively, for a case in which reproduced audio signal RAS10 is a far-end communications signal (i.e., received in an encoded form), activity detector AD10 may be implemented to determine whether reproduced audio signal RAS10 is active based on a value of a parameter within the encoded signal (e.g., a parameter that indicates a coding mode to be used to decode the frame). Activity detector AD10 may also be implemented to continue to indicate that reproduced audio signal RAS10 is active during a hangover period (e.g., two, three, four, or five frames) after such activity ceases.

As shown in the block diagram of FIG. 21B, subband gain factor calculator GC130 includes an implementation RC110 of reinforcement factor calculator RC100, which is configured to set reinforcement factor R(i) to a default value (e.g., 1.0) in response to a state of activity detection signal SD10 that indicates inactivity. Apparatus A200 may be similarly implemented to include an instance of activity detector AD10 and a corresponding implementation GC230 of gain factor calculator GC200, which includes a similar implementation RC210 of reinforcement factor calculator RC200 as shown in the block diagram of FIG. 21C.

It may be desirable to implement smoother GS100 to modify the gain smoothing operation in response to indication of certain activity transitions within reproduced audio signal RAS10. During a hangover period (e.g., two, three, four, or five frames) after activity in reproduced audio signal RAS10 ceases, for example, it may be desirable for smoother GS100 to continue to smooth reinforcement factor R(i) with the same smoothing factor as the sound-active frames. After the hangover period, it may be desirable for smoother GS100 to reduce smoothing factor η (e.g., for all subbands) to allow the subband gain factors G(i) to decrease relatively quickly (e.g., to a default value of reinforcement factor R(i), such as 1.0 as noted above). Such an operation is not likely to produce much artifact, in that the filter input is minimal because there is no receive activity. Such an implementation of apparatus A100 (e.g., A120, A200, A220) may include an instance of activity detector AD10 and an implementation of smoother GS100 that is configured to modify the gain smoothing operation in response to a state of activity detection signal SD10 that indicates inactivity.

Additionally or in the alternative, it may be desirable to implement smoother GS100 to modify the gain smoothing operation in response to indication of certain activity transitions within subbands of reproduced audio signal RAS10. A “global onset frame” is defined as a frame in which (A) in the immediately preceding frames for more than (alternatively, at least) a predetermined number of frames (an activation threshold period of, e.g., two, three, or four frames), all subbands are inactive, and (B) one or more subbands of the frame are active. For global onset frames, it may be desirable for smoother GS100 to reduce smoothing factor η for the global onset subband (or subbands) to allow the subband gain factor for the onset subband to increase fairly quickly. Such an operation is not likely to produce much artifact, in that the filter memory will be filled with almost zero values.

A “band onset frame” is defined as a frame that is not a global onset frame and in which (A) a subband of the frame is active and (B) in the immediately preceding frames for more than (alternatively, at least) an activation threshold period, the currently active subband was inactive. For band onset frames, it may be desirable for smoother GS100 to set smoothing factor η for the band onset subband (or subbands) to allow the subband gain factor for the onset subband to increase rather quickly. Because the subbands overlap for a considerable amount, however, and the speech high-frequency components can be very weak for some periods, a gain change in the band onset frames that is too quick can be annoying. Therefore, it may be desirable for the adaptation speed of the smoothing for band onset frames to be less rapid (e.g., for the value of smoothing factor η to be greater) than for global onset frames.

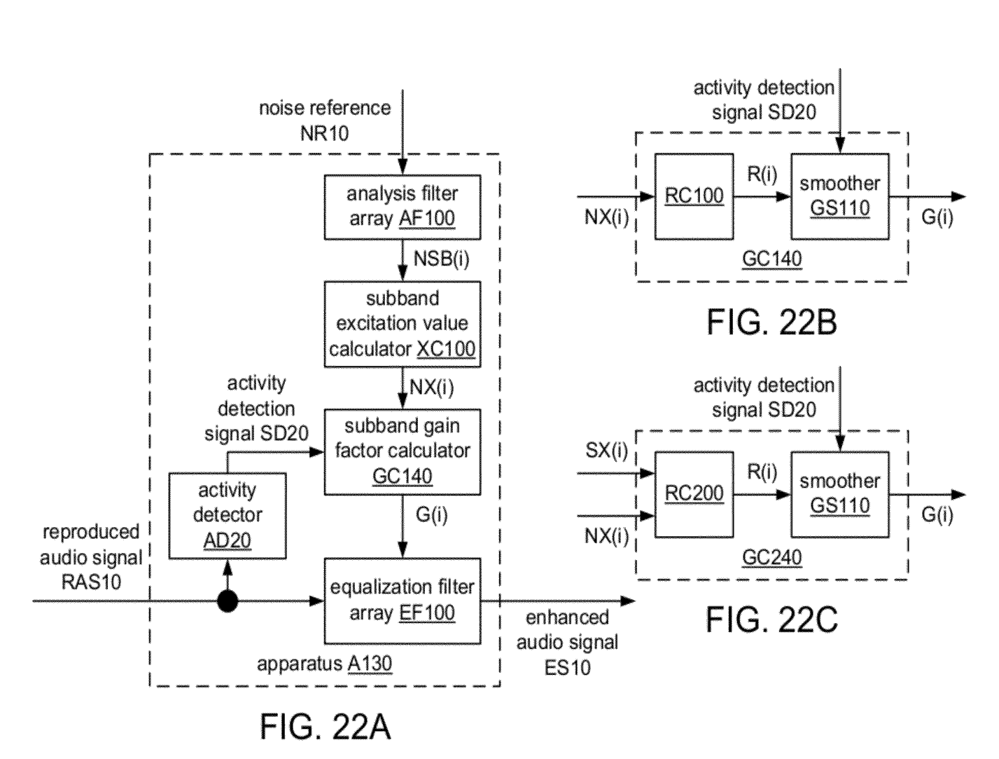

FIG. 22A shows a block diagram of such an implementation A130 of apparatus A100 that includes an activity detector AD20 and an implementation GC140 of subband gain factor calculator GC120. Activity detector AD20 produces an activity detection signal SD20 that indicates an onset of activity for one or more subbands of reproduced audio signal RAS10. Activity detector AD20 may be implemented to produce such an indication for each of the subbands based on the frame energy of the subband and/or a change over time in the frame energy of the subband. For example, activity detector AD20 may be implemented to produce activity detection signal SD20 by calculating, for each of the subbands, a difference between the current and previous frame energies of the subband and comparing the difference to a threshold value for each subband. For a case in which reproduced audio signal RAS10 is a far-end communications signal (i.e., received in an encoded form), activity detector AD20 may be implemented to determine whether the preceding frame of reproduced audio signal RAS10 is inactive based on a value of a parameter within the encoded signal (e.g., a parameter that indicates a coding mode to be used to decode the frame), and to determine whether a subband is currently active based on the frame energy of the subband (e.g., as compared to a threshold value and/or a corresponding noise reference for the subband).

As shown in the block diagram of FIG. 22B, subband gain factor calculator GC140 includes an implementation GS110 of smoother GS100, which is configured to set reinforcement factor R(i) to a default value (e.g., 1.0) in response to a state of activity detection signal SD10 that indicates inactivity. Apparatus A200 may be similarly implemented to include an instance of activity detector AD20 and a corresponding implementation GC240 of subband gain factor calculator GC220, which includes an instance of smoother GS110 as shown in the block diagram of FIG. 22C. In a further implementation of apparatus A130, reinforcement factor calculator RC100 is implemented as an instance of calculator RC110, and activity detector AD20 is implemented to also produce activity detection signal SD10 to calculator RC110 as described herein with reference to FIGS. 21A and 21B. Apparatus A200 may be similarly implemented (e.g., such that calculator GC240 is implemented to include calculator RC210 disposed to receive activity detection signal AD10, as described herein with reference to FIG. 21C).

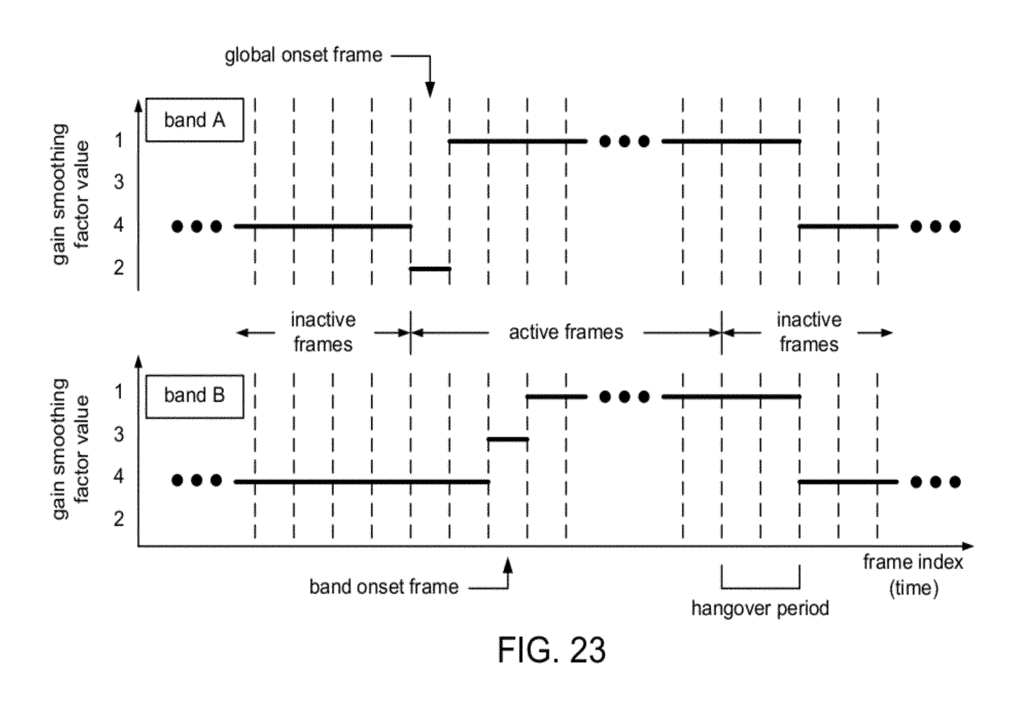

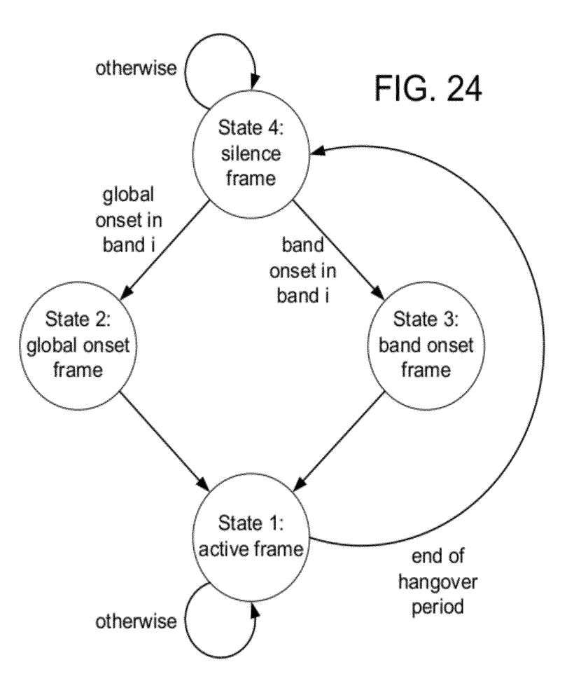

FIG. 23 shows an example of such activity transitions for the same frames of two different subbands A and B of reproduced audio signal RAS10, where the vertical dashed lines indicate frame boundaries in time and the hangover period is two frames. In this example, the gain smoothing factor values { 1, 2, 3, 4} applied by smoother GS110 correspond to the activity states { active (stationary), global onset, band onset, silence (inactive)}, respectively. Examples for the gain smoothing factor values include the following: 1={0.9, 0.9375}; 2={0.5, 0.25}; 3={0.75, 0.85}; 4={0.5, 0.75, 0.875}. FIG. 24 shows an example of a state diagram for smoother GS110 for each subband, wherein a transition occurs at each frame.

In a cascaded implementation of equalization filter array EF100, overlap among the passbands of the filters of the array may cause the effective gain of the cascade in a subband to be higher than intended. It may be desirable to configure subband gain calculator GC100 (or GC200) to perform a scaling operation on the subband gain factor values to compensate for this effect. FIG. 20B shows a block diagram of an implementation GC150 of subband gain factor calculator GC120 that includes a scaler SC100. Scaler SC100 performs a linear operation to map the subband gain factors to the biquad filters. In one example, scaler SC100 is implemented to perform such scaling by applying a q×q matrix A to the vector of subband gain factors G(i), where q is the number of subbands and the matrix A may be calculated based on the response characteristics of equalization filter array EF100.

An equalization scheme may be modified to have a lower gain in one or more low-frequency bands (e.g., to prevent unnecessary low-frequency boosting, which may result in a muffled sound) and/or a higher gain in one or more high-frequency bands (e.g., to improve intelligibility).

Capability of preserving voice color is a potential advantage of an LP-based equalization scheme, but such a scheme may also be configured to further enhance the intelligibility while altering the voice color. Some people may prefer preservation of voice color, while other people may prefer enhanced intelligibility with altered voice color. Apparatus A100 may be implemented to include selectable control of this parameter by, for example, adding an artificial spectral tilt to enhanced audio signal ES10.

In one example, band-weighting parameters z are used to weight the desired loudness of enhanced audio signal ES10 according to an expression such as

z×N′_{Q}(SX(i))=N′ₚₐᵣₜᵢₐₗ(R(i,k)²SX(i), NX(i)).

Such band-weighting parameters z may be implemented as a vector multiplied to the desired loudness, which may be used to control the relative loudness of different frequencies (e.g., the spectral tilt). For example, the loudness multiplication vector z={z_i} may be specified as {1.0, 1.0. 1.5, 2.0} for a case in which it is desired to make the output sound in the first two bands as loud as the original signal would be in a clean environment, and to double the loudness in the fourth band. It may be desirable for this vector to be inactive by default (e.g., all values set to 1.0).

It may be desirable to configure such loudness tilt control to be SNR-dependent. For example, it may be desirable to include a flag to decide whether the spectral tilt is decided according to the SNR (e.g., to enable selection of the loudness multiplication vector according to the SNR). Such a flag may be used to make the equalization output louder and/or more intelligible in lower SNR conditions (e.g., to provide more high-frequency enhancement for lower near-end SNR, or to provide more high-frequency enhancement for lower far-end SNR). It may be desirable for the default value of this flag to be “disabled.” In one example, this option is configured to have four values for spectral tilt; it may be desirable to include thresholds for SNR and smoothing factor of the vector multiplied to the desired loudness.

It may be desirable for an implementation of apparatus A100 to incorporate characteristics of the microphones, loudspeakers, and/or other modules (e.g., modules in the receive chain after apparatus A100, modules in the transmit chain prior to noise estimation) for better equalization performance. Regarding the microphone, for example, it may be desirable to consider (e.g., to modify the transfer function in the first and/or second block of FIG. 5B for noise reference input according to) the transfer function from the sound pressure level of noise at the ear reference point (ERP) or eardrum reference point (DRP) to the digital noise reference signal (e.g., the ratio between the digital power of noise reference NR10 and the sound pressure level of the noise at ERP or DRP for each band).

Regarding the loudspeaker, it may be desirable to consider (e.g., to modify the transfer function in the first and/or second block of FIG. 5B for far-end speech input according to) the transfer function from enhanced audio signal ES10 to the sound pressure level at ERP or DRP (e.g., the ratio between the digital signal power of enhanced audio signal ES10 and the sound pressure level of the corresponding acoustic signal at ERP or DRP for each band).

Other modules in a receive chain or a transmit chain may include one or more of the following: a transmit noise suppression module that may be used to nullify the effect of near-end noise to the far-end listener; a receive far-end noise suppression module; an acoustic echo canceller that may be used to nullify the effect of acoustic echo; an AVC or equalization module. An adaptive noise cancellation (ANC) module may be included in the receive chain to nullify the effect of near-end noise to the near-end listener. A peak limiter, a bass boosting or perceptual bass enhancement (PBE) filter, and/or a DRC (dynamic range control) module may be used in the receive chain to nullify the effect of imperfect loudspeaker response. A Widevoice module may be used to nullify the effect of limited bandwidth. An AGC module may be used to nullify the effect of speech level variability. A Slowtalk module may be used to nullify the effect of fast speech rate. A speech codec may be used to nullify the effect of limited bit rate. It may be desirable to improve some aspects of speech while sacrificing other aspects.

It may be desirable to configure the operation of an implementation of apparatus A100 according to interactions with other modules in the transmit and/or receive chain (e.g., residual echo of a linear echo canceller). The performance of apparatus A100 may depend on the performance of the linear echo canceller, in that poor echo cancellation may result in positive feedback. Even with good linear echo cancellation, however, nonlinear echoes may remain in noise reference NR10. To increase robustness to echo cancellation performance, it may be desirable not to update the noise estimate whenever there is far-end activity. While this modification may increase equalization robustness to echo cancellation performance, it may also reduce equalization performance for nonstationary noise, so it may also be desirable to configure this modification so that it may be selectably enabled or disabled.

Other interactions according to which performance of apparatus A100 may be tuned include: effect of equalization on double-talk performance of an acoustic echo canceller; adapting a bass boosting filter into apparatus A100; interactions with an active noise canceller; effects on in-call audio. An implementation of apparatus A100 may amplify artifacts potentially incurred by previous modules such as ECNS at the far-end transmit chain, speech codec and channel effect, far-end noise suppression at the near-end receive chain, a Slowtalk module, a Widevoice module, and/or an MB-ADRC (multiband audio dynamic range control) module.

Other topics include estimation of the noise level at the opposite ear (possibly related to localization of an acoustic source), which may be used to achieve a binaural masking effect.

As noted above, it may be desirable to obtain sensed audio signal SAS10 by performing one or more preprocessing operations on two or more microphone signals. The microphone signals are typically sampled, may be pre-processed (e.g., filtered for echo cancellation, noise reduction, spectrum shaping, etc.), and may even be pre-separated (e.g., by another SSP filter or adaptive filter) to obtain sensed audio signal SAS10. For acoustic applications such as speech, typical sampling rates range from 8, 12, or 16 kHz to 32 or 48 kHz.

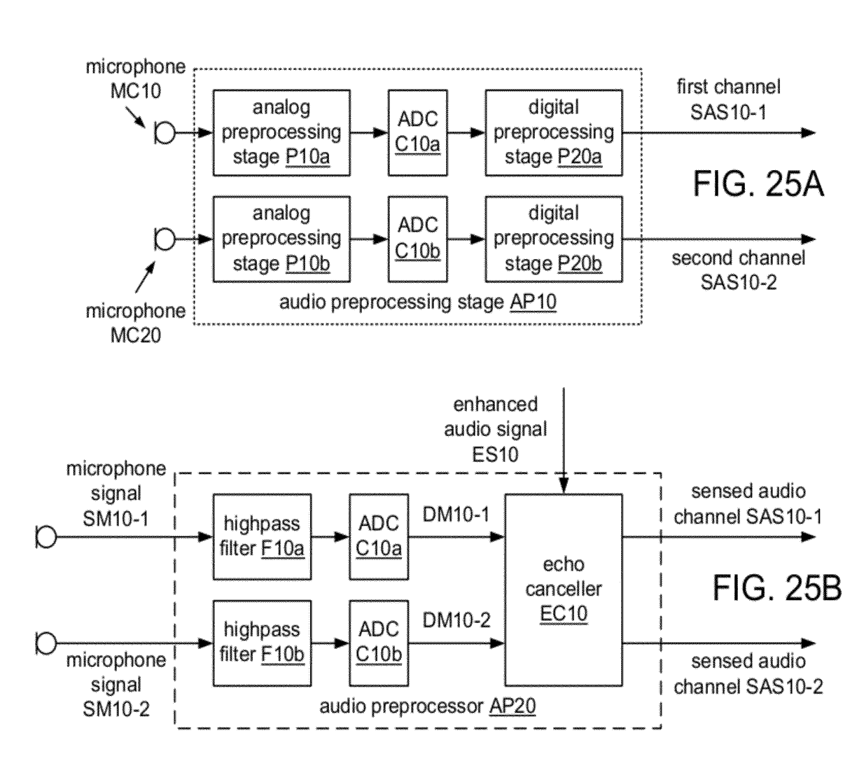

Apparatus A100 may include an audio preprocessor AP10 as shown in FIG. 25A that is configured to digitize M analog microphone signals SM10-1 to SM10-M to produce M channels SAS10-1 to SAS10-M of sensed audio signal SAS10. In this particular example, audio preprocessor AP10 is configured to digitize a pair of analog microphone signals to produce a pair of channels SAS10-1, SAS10-2 of sensed audio signal SAS10. Audio preprocessor AP10 may also be configured to perform other preprocessing operations on the microphone signals in the analog and/or digital domains, such as spectral shaping and/or echo cancellation. For example, audio preprocessor AP10 may be configured to apply one or more gain factors to each of one or more of the microphone signals, in either of the analog and digital domains. The values of these gain factors may be selected or otherwise calculated such that the microphones are matched to one another in terms of frequency response and/or gain.

FIG. 25B shows a block diagram of an audio preprocessor AP20 that includes first and second analog-to-digital converters (ADCs) C10a and C10b. First ADC C10a is configured to digitize microphone signal SM10-1 to obtain microphone signal DM10-1, and second ADC C10b is configured to digitize microphone signal SM10-2 to obtain microphone signal DM10-2. Typical sampling rates that may be applied by ADCs C10a and C10b for acoustic applications include 8 kHz, 12 kHz, 16 kHz, and other frequencies in the range of from about 8 to about 16 kHz, although sampling rates as high as about 44.1, 48, and 192 kHz may also be used. In this example, audio preprocessor AP20 also includes a pair of highpass filters F10a and F10b that are configured to perform analog spectral shaping operations (e.g., with a cutoff frequency of 50, 100, or 200 Hz) on microphone signals SM10-1 and SM10-2, respectively. It may be desirable to implement an audio preprocessor (e.g., AP10 or AP20) to scale the microphone signals according to microphone response characteristics (e.g., to match the noise reference to the sound pressure level actually experienced by the user).

Although FIGS. 25A and 25B show two-channel implementations, it will be understood that the same principles may be extended to an arbitrary number of microphones and corresponding channels of sensed audio signal SAS10 (e.g., a three-, four-, or five-channel implementation).

It is expressly noted that the microphones may be implemented more generally as transducers sensitive to radiations or emissions other than sound. In one such example, the microphone pair is implemented as a pair of ultrasonic transducers (e.g., transducers sensitive to acoustic frequencies greater than fifteen, twenty, twenty-five, thirty, forty, or fifty kilohertz or more).

In a device for portable voice communications, such as a handset or headset, the center-to-center spacing between adjacent microphones MC10 and MC20 of an array is typically in the range of from about 1.5 cm to about 4.5 cm, although a larger spacing (e.g., up to 10 or 15 cm) is also possible in a device such as a handset or smartphone, and even larger spacings (e.g., up to 20, 25 or 30 cm or more) are possible in a device such as a tablet computer. In a hearing aid, the center-to-center spacing between adjacent microphones of a microphone array may be as little as about 4 or 5 mm. The microphones of an array may be arranged along a line or, alternatively, such that their centers lie at the vertices of a two-dimensional (e.g., triangular) or three-dimensional shape. In general, however, the microphones of an array may be disposed in any configuration deemed suitable for the particular application.

During the operation of a multi-microphone audio sensing device, the microphone array produces a multichannel signal in which each channel is based on the response of a corresponding one of the microphones to the acoustic environment. One microphone may receive a particular sound more directly than another microphone, such that the corresponding channels differ from one another to provide collectively a more complete representation of the acoustic environment than can be captured using a single microphone.

Audio preprocessor AP20 also includes an echo canceller EC10 that is configured to cancel echoes from the microphone signals, based on information from enhanced audio signal ES10. Echo canceller EC10 may be arranged to receive enhanced audio signal ES10 from a time-domain buffer. In one such example, the time-domain buffer has a length of ten milliseconds (e.g., eighty samples at a sampling rate of eight kHz, or 160 samples at a sampling rate of sixteen kHz). During operation of a communications device that includes an implementation of apparatus A100 in certain modes, such as a speakerphone mode and/or a push-to-talk (PTT) mode, it may be desirable to suspend the echo cancellation operation (e.g., to configure echo canceller EC10 to pass the microphone signals unchanged).

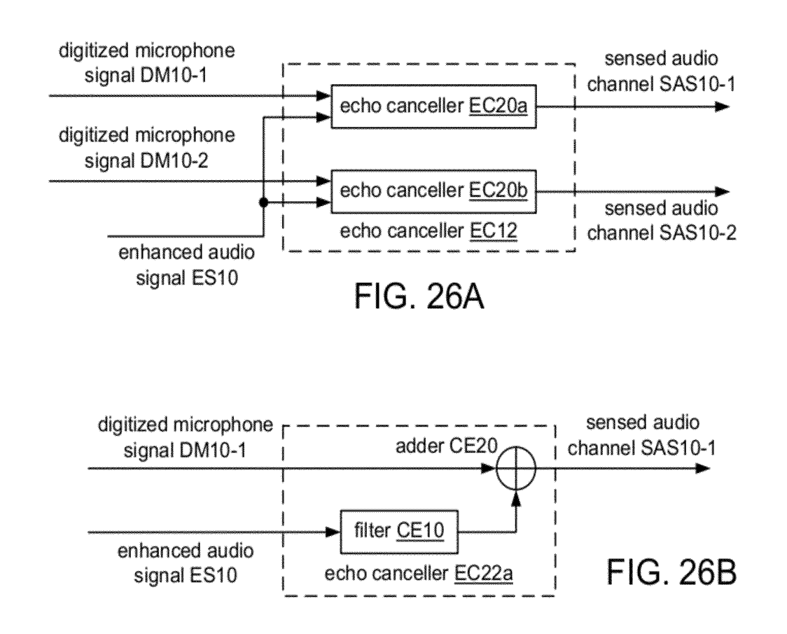

FIG. 26A shows a block diagram of an implementation EC12 of echo canceller EC10 that includes two instances EC20a and EC20b of a single-channel echo canceller. In this example, each instance of the single-channel echo canceller is configured to process a corresponding one of microphone signals DM10-1, DM10-2 to produce a corresponding channel SAS10-1, SAS10-2 of sensed audio signal SAS10. The various instances of the single-channel echo canceller may each be configured according to any technique of echo cancellation (for example, a least mean squares technique and/or an adaptive correlation technique) that is currently known or is yet to be developed. For example, echo cancellation is discussed at paragraphs [00138]-[00140] of U.S. Publ. Pat. Appl. No. 2009/0022336 of Visser et al, entitled “SYSTEMS, METHODS, AND APPARATUS FOR SIGNAL SEPARATION” (beginning with “An apparatus” and ending with “B500”), which paragraphs are hereby incorporated by reference for purposes limited to disclosure of echo cancellation issues, including but not limited to design, implementation, and/or integration with other elements of an apparatus.

FIG. 26B shows a block diagram of an implementation EC22a of echo canceller EC20a that includes a filter CE10 arranged to filter enhanced audio signal ES10 and an adder CE20 arranged to combine the filtered signal with the microphone signal being processed. The filter coefficient values of filter CE10 may be fixed. Alternatively, at least one (and possibly all) of the filter coefficient values of filter CE10 may be adapted during operation of apparatus A100.

Echo canceller EC20b may be implemented as another instance of echo canceller EC22a that is configured to process microphone signal DM10-2 to produce sensed audio channel SAS10-2. Alternatively, echo cancellers EC20a and EC20b may be implemented as the same instance of a single-channel echo canceller (e.g., echo canceller EC22a) that is configured to process each of the respective microphone signals at different times.

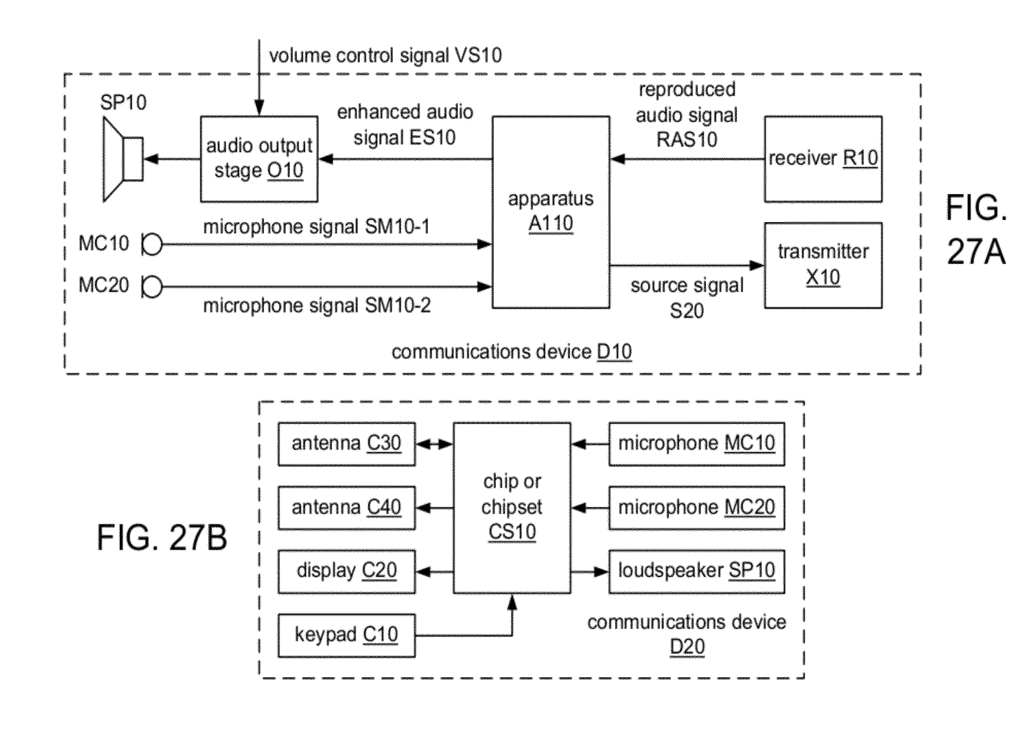

An implementation of apparatus A100 may be included within a transceiver (e.g., a cellular telephone or wireless headset). FIG. 27A shows a block diagram of such a communications device D10 that includes an instance of apparatus A110 (e.g., an implementation of apparatus A200 that includes SSP filter SS10). Device D10 includes a receiver R10 coupled to apparatus A110 that is configured to receive a radio-frequency (RF) communications signal and to decode and reproduce an audio signal encoded within the RF signal as reproduced audio signal RAS10. Device D10 also includes a transmitter X10 coupled to apparatus A110 that is configured to encode a source signal S20 (e.g., near-end speech) and to transmit an RF communications signal that describes the encoded audio signal. Device D10 also includes an audio output stage AO10 that is configured to process enhanced audio signal ES10 (e.g., to convert enhanced audio signal ES10 to an analog signal) and to output the processed audio signal to loudspeaker SP10, which may be directed at an ear canal of the user and/or located within two, five, or ten centimeters of a user's ear canal during use of the device. At least one of microphones MC10 and MC20 may also be located within two, five, or ten centimeters of a user's ear canal during use of the device. For example, microphones MC10 and/or MC20 and loudspeaker SP10 may be located within a common housing. In this example, audio output stage AO10 is configured to control the volume of the processed audio signal according to a level of volume control signal VS10, which level may vary under user control.

It may be desirable for an implementation of apparatus A110 to reside within a communications device such that other elements of the device (e.g., a baseband portion of a mobile station modem (MSM) chip or chip set) are arranged to perform further audio processing operations on sensed audio signal S10. In designing an echo canceller to be included in an implementation of apparatus A110 (e.g., echo canceller EC10), it may be desirable to take into account possible synergistic effects between this echo canceller and any other echo canceller of the communications device (e.g., an echo cancellation module of the MSM chip or chipset).

FIG. 27B shows a block diagram of an implementation D20 of communications device D10. Device D20 includes a chip or chipset CS10 (e.g., an MSM chipset) that includes elements of receiver R10 and transmitter X10 and may include one or more processors that are configured to perform an instance of method M100 or M200 or otherwise embody an instance of an implementation of apparatus A110. Device D20 is configured to receive and transmit the RF communications signals via an antenna C30. Device D20 may also include a diplexer and one or more power amplifiers in the path to antenna C30. Chip/chipset CS10 is also configured to receive user input via keypad C10 and to display information via display C20. In this example, device D20 also includes one or more antennas C40 to support Global Positioning System (GPS) location services and/or short-range communications with an external device such as a wireless (e.g., Bluetooth™) headset. In another example, such a communications device is itself a Bluetooth™ headset and lacks keypad C10, display C20, and antenna C30.

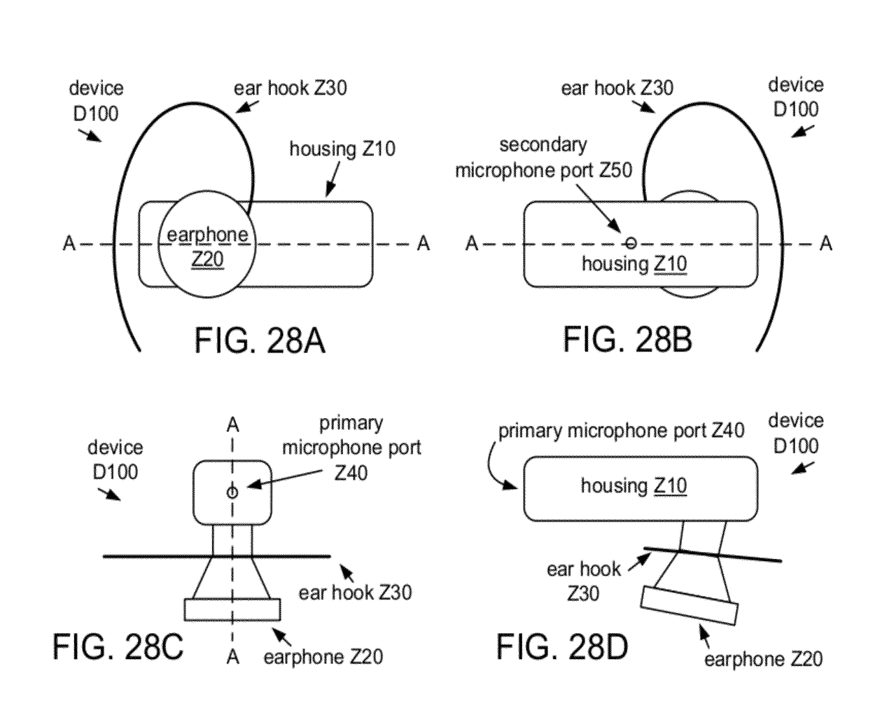

FIGS. 28A to 28D show various views of a multi-microphone portable audio sensing device D100 that may include an implementation of apparatus A100 as described herein. Device D100 is a wireless headset that includes a housing Z10 which carries a multimicrophone array and an earphone Z20 that includes loudspeaker SP10 and extends from the housing. In general, the housing of a headset may be rectangular or otherwise elongated as shown in FIGS. 28A, 28B, and 28D (e.g., shaped like a miniboom) or may be more rounded or even circular. The housing may also enclose a battery and a processor and/or other processing circuitry (e.g., a printed circuit board and components mounted thereon) and may include an electrical port (e.g., a mini-Universal Serial Bus (USB) or other port for battery charging) and user interface features such as one or more button switches and/or LEDs. Typically the length of the housing along its major axis is in the range of from one to three inches.

Typically each microphone of the array is mounted within the device behind one or more small holes in the housing that serve as an acoustic port. FIGS. 28B to 28D show the locations of the acoustic port Z40 for the primary microphone of a two-microphone array of device D100 and the acoustic port Z50 for the secondary microphone of this array, which may be used to produce multichannel sensed audio signal SAS10. In this example, the primary and secondary microphones are directed away from the user's ear to receive external ambient sound.

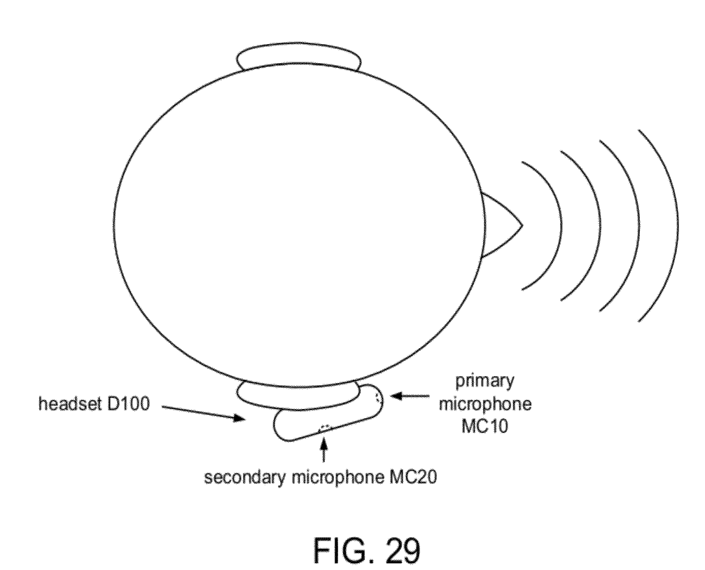

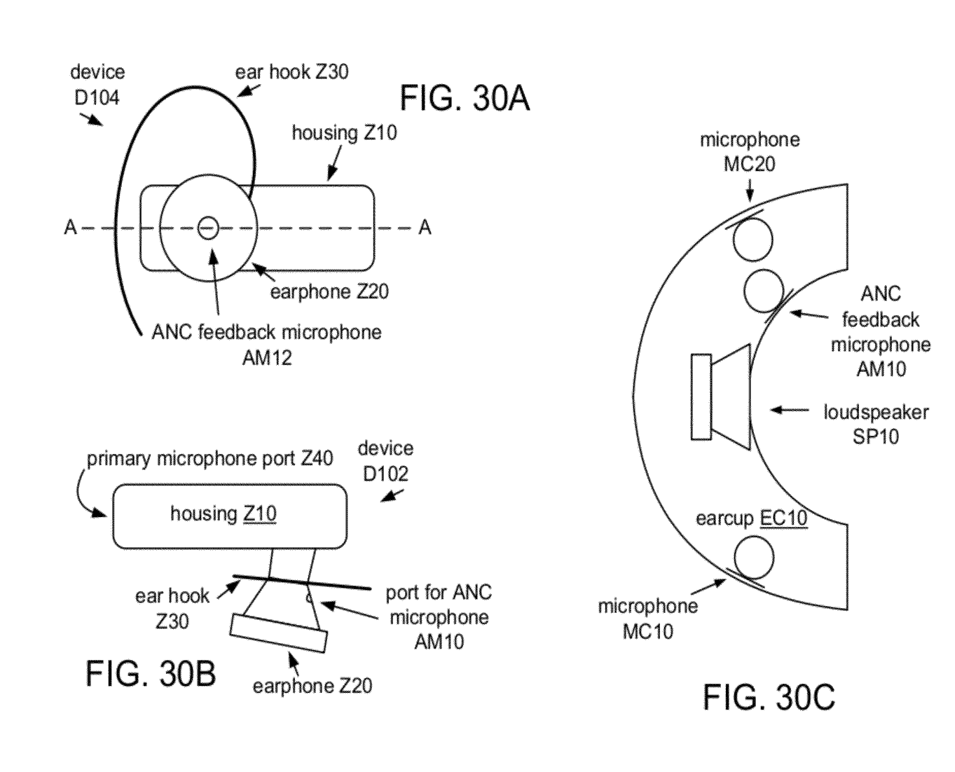

FIG. 29 shows a top view of headset D100 mounted on a user's ear in a standard orientation relative to the user's mouth. FIG. 30A shows a view of an implementation D102 of headset D100 that includes at least one additional microphone AM10 to produce an acoustic error signal (e.g., for ANC applications). FIG. 30B shows a view of an implementation D104 of headset D100 that includes a feedback implementation AM12 of microphone AM10 that is directed at the user's ear (e.g., down the user's ear canal) to produce an acoustic error signal (e.g., for ANC applications).

FIG. 30C shows a cross-section of an earcup EC10 that may be implemented to include apparatus A100 (e.g., to include apparatus A200). Earcup EC10 includes microphones MC10 and MC20 and a loudspeaker SP10 that is arranged to reproduce enhanced audio signal ES10 to the user's ear. It may be desirable to position microphone MC10 to be as close as possible to the user's mouth during use. Earcup EC10 also includes a feedback ANC microphone AM10 that is directed at the user's ear and arranged to receive an acoustic error signal (e.g., via an acoustic port in the earcup housing). It may be desirable to insulate the ANC microphone from receiving mechanical vibrations from loudspeaker SP10 through the material of the earcup. earcup EC10 may include an ANC module as noted herein.

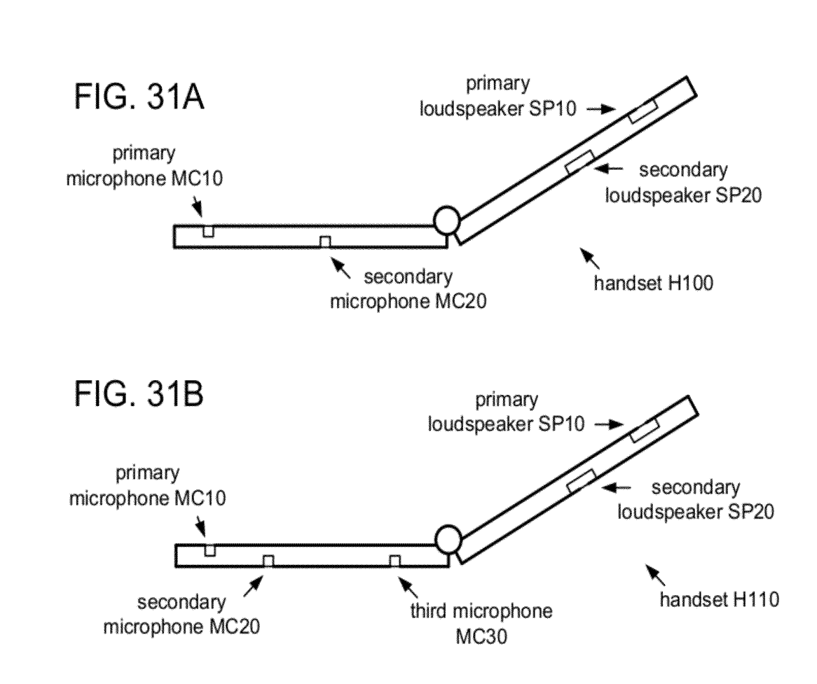

FIG. 31A shows a diagram of a two-microphone handset H100 (e.g., a clamshell-type cellular telephone handset) in a first operating configuration that may be implemented as an instance of device D10. Handset H100 includes a primary microphone MC10 and a secondary microphone MC20. In this example, handset H100 also includes a primary loudspeaker SP10 and a secondary loudspeaker SP20. When handset H100 is in the first operating configuration, primary loudspeaker SP10 is active and secondary loudspeaker SP20 may be disabled or otherwise muted. It may be desirable for primary microphone MC10 and secondary microphone MC20 to both remain active in this configuration to support spatially selective processing techniques for speech enhancement and/or noise reduction. FIG. 31B shows a diagram of an implementation H110 of handset H100 that includes a third microphone MC30.

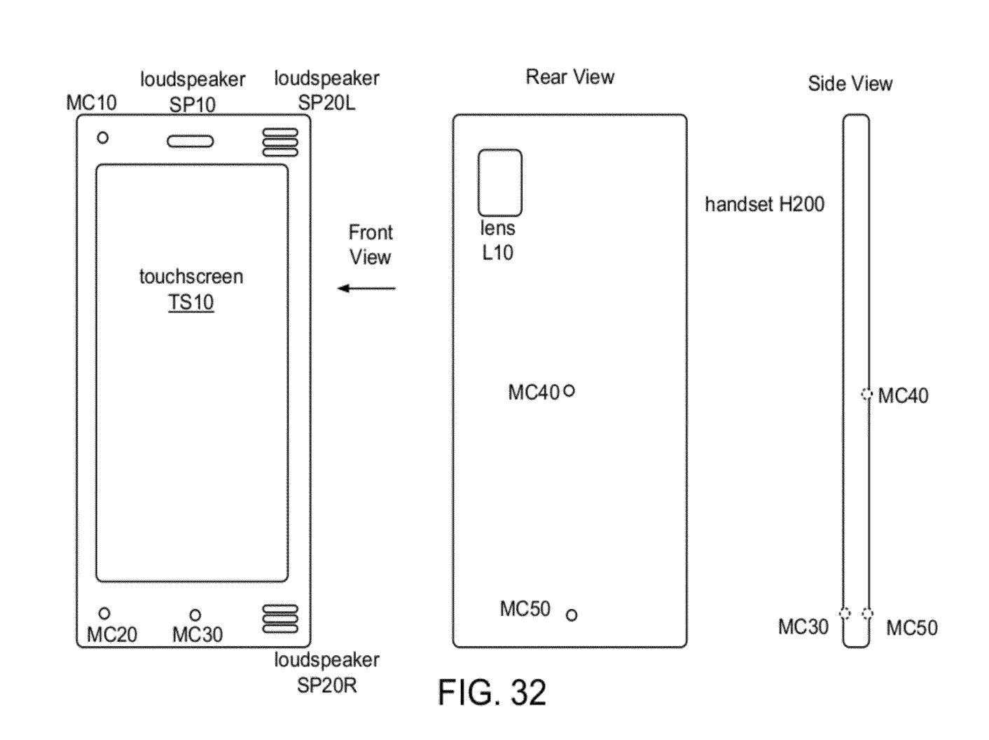

FIG. 32 shows front, rear, and side views of a handset H200 (e.g., a smartphone) that may be implemented as an instance of device D10. Handset H200 includes three microphones MC10, MC20, and MC30 arranged on the front face; and two microphones MC40 and MC50 and a camera lens L10 arranged on the rear face. A loudspeaker SP10 is arranged in the top center of the front face near microphone MC10, and two other loudspeakers SP20L, SP20R are also provided (e.g., for speakerphone applications). A maximum distance between the microphones of such a handset is typically about ten or twelve centimeters. It is expressly disclosed that applicability of systems, methods, and apparatus disclosed herein is not limited to the particular examples noted herein.

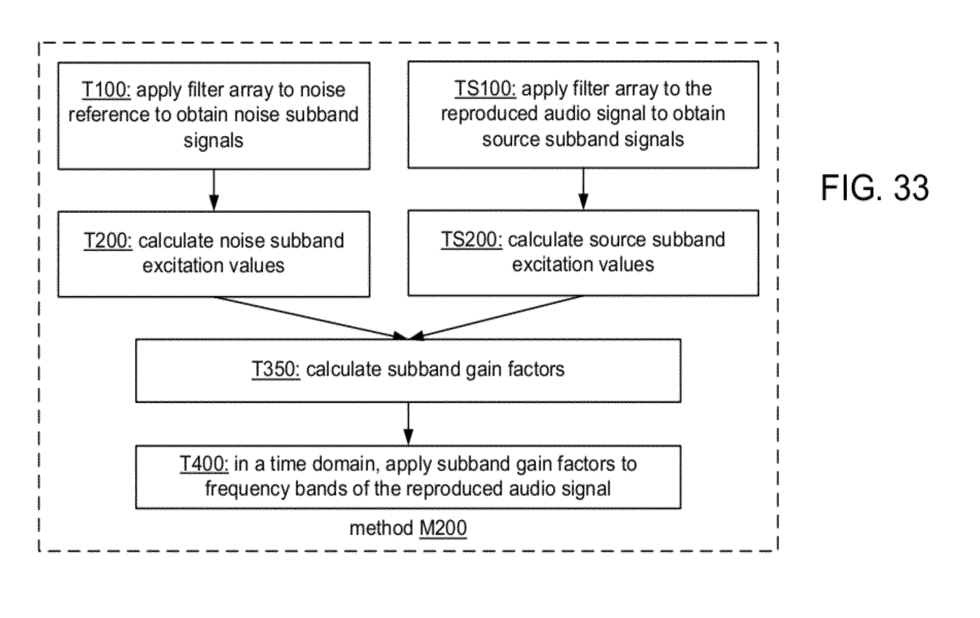

FIG. 33 shows a flowchart of an implementation M200 of method M100 that includes tasks TS100, TS200, and an implementation T350 of task T300. Task TS100 applies a subband filter array to the reproduced audio signal to produce a plurality of time-domain noise subband signals (e.g., as described herein with reference to source analysis filter array AF100s). Based on information from the plurality of time-domain source subband signals, task TS200 calculates a plurality of source subband excitation values (e.g., as described herein with reference to source subband excitation value calculator XC100s). Based on the plurality of noise subband excitation values and the plurality of source subband excitation values, task TS300 calculates a plurality of subband gain factors (e.g., as described herein with reference to subband gain factor calculator GC200).

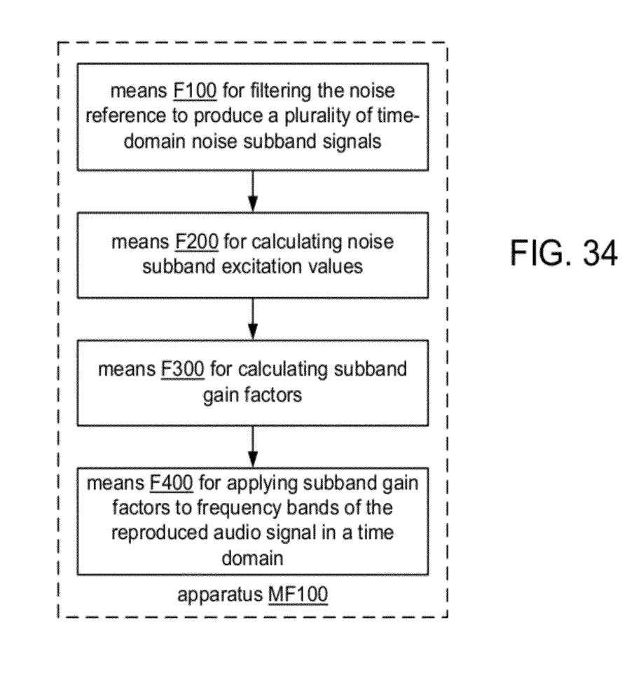

FIG. 34 shows a block diagram of an apparatus MF100 for using information from a near-end noise reference to process a reproduced audio signal according to a general configuration. Apparatus MF100 includes means F100 for filtering the near-end noise reference to produce a plurality of time-domain noise subband signals (e.g., as described herein with reference to task T100 and/or array AF100). Apparatus MF100 also includes means F200 for calculating a plurality of noise subband excitation values based on information from the plurality of time-domain noise subband signals (e.g., as described herein with reference to task T200 and/or subband excitation value calculator XC100). Apparatus MF100 also includes means F300 for calculating a plurality of subband gain factors based on the plurality of noise subband excitation values (e.g., as described herein with reference to task T300 and/or subband gain factor calculator GC100). Apparatus MF100 also includes means F400 for applying the plurality of subband gain factors to a plurality of frequency bands of the reproduced audio signal in a time domain to produce an enhanced audio signal (e.g., as described herein with reference to task T400 and/or array EF100).

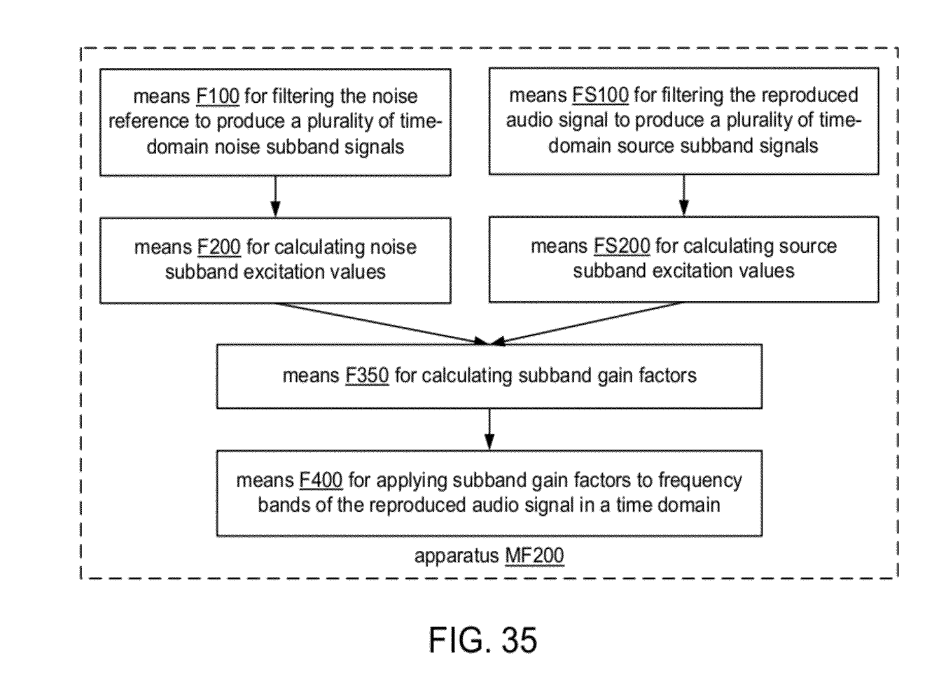

FIG. 35 shows a block diagram of an implementation MF200 of apparatus MF100. Apparatus MF200 includes means FS100 for filtering the reproduced audio signal to produce a plurality of time-domain source subband signals (e.g., as described herein with reference to source analysis filter array AF100s). Apparatus MF200 also includes means FS200 for calculating source subband excitation values based on information from the plurality of time-domain source subband signals (e.g., as described herein with reference to source subband excitation value calculator XC100s). Apparatus MF200 also includes an implementation F350 of means F300 for calculating a plurality of subband gain factors based on the plurality of noise subband excitation values and the plurality of source subband excitation values (e.g., as described herein with reference to subband gain factor calculator GC200).

The methods and apparatus disclosed herein may be applied generally in any transceiving and/or audio sensing application, especially mobile or otherwise portable instances of such applications. For example, the range of configurations disclosed herein includes communications devices that reside in a wireless telephony communication system configured to employ a code-division multiple-access (CDMA) over-the-air interface. Nevertheless, it would be understood by those skilled in the art that a method and apparatus having features as described herein may reside in any of the various communication systems employing a wide range of technologies known to those of skill in the art, such as systems employing Voice over IP (VoIP) over wired and/or wireless (e.g., CDMA, TDMA, FDMA, and/or TD-SCDMA) transmission channels.

It is expressly contemplated and hereby disclosed that communications devices disclosed herein may be adapted for use in networks that are packet-switched (for example, wired and/or wireless networks arranged to carry audio transmissions according to protocols such as VoIP) and/or circuit-switched. It is also expressly contemplated and hereby disclosed that communications devices disclosed herein may be adapted for use in narrowband coding systems (e.g., systems that encode an audio frequency range of about four or five kilohertz) and/or for use in wideband coding systems (e.g., systems that encode audio frequencies greater than five kilohertz), including whole-band wideband coding systems and split-band wideband coding systems.

Examples of codecs that may be used with, or adapted for use with, transmitters and/or receivers of communications devices as described herein include the Enhanced Variable Rate Codec, as described in the Third Generation Partnership Project 2 (3GPP2) document C.S0014-C, v1.0, entitled “Enhanced Variable Rate Codec, Speech Service Options 3, 68, and 70 for Wideband Spread Spectrum Digital Systems,” February 2007 (available online at www-dot-3gpp-dot-org); the Selectable Mode Vocoder speech codec, as described in the 3GPP2 document C.S0030-0, v3.0, entitled “Selectable Mode Vocoder (SMV) Service Option for Wideband Spread Spectrum Communication Systems,” January 2004 (available online at www-dot-3gpp-dot-org); the Adaptive Multi Rate (AMR) speech codec, as described in the document ETSI TS 126 092 V6.0.0 (European Telecommunications Standards Institute (ETSI), Sophia Antipolis Cedex, FR, December 2004); and the AMR Wideband speech codec, as described in the document ETSI TS 126 192 V6.0.0 (ETSI, December 2004). Such a codec may be used, for example, to recover the reproduced audio signal from a received wireless communications signal.

The presentation of the described configurations is provided to enable any person skilled in the art to make or use the methods and other structures disclosed herein. The flowcharts, block diagrams, and other structures shown and described herein are examples only, and other variants of these structures are also within the scope of the disclosure. Various modifications to these configurations are possible, and the generic principles presented herein may be applied to other configurations as well. Thus, the present disclosure is not intended to be limited to the configurations shown above but rather is to be accorded the widest scope consistent with the principles and novel features disclosed in any fashion herein, including in the attached claims as filed, which form a part of the original disclosure.

Those of skill in the art will understand that information and signals may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

Important design requirements for implementation of a configuration as disclosed herein may include minimizing processing delay and/or computational complexity (typically measured in millions of instructions per second or MIPS), especially for computation-intensive applications, such as playback of compressed audio or audiovisual information (e.g., a file or stream encoded according to a compression format, such as one of the examples identified herein) or applications for wideband communications (e.g., voice communications at sampling rates higher than eight kilohertz, such as 12, 16, 32, 44.1, 48, or 192 kHz).

An apparatus as disclosed herein (e.g., apparatus A100, A200, MF100, MF200) may be implemented in any combination of hardware with software, and/or with firmware, that is deemed suitable for the intended application. For example, the elements of such an apparatus may be fabricated as electronic and/or optical devices residing, for example, on the same chip or among two or more chips in a chipset. One example of such a device is a fixed or programmable array of logic elements, such as transistors or logic gates, and any of these elements may be implemented as one or more such arrays. Any two or more, or even all, of these elements may be implemented within the same array or arrays. Such an array or arrays may be implemented within one or more chips (for example, within a chipset including two or more chips).

One or more elements of the various implementations of the apparatus disclosed herein (e.g., apparatus A100, A200, MF100, MF200) may be implemented in whole or in part as one or more sets of instructions arranged to execute on one or more fixed or programmable arrays of logic elements, such as microprocessors, embedded processors, IP cores, digital signal processors, FPGAs (field-programmable gate arrays), ASSPs (application-specific standard products), and ASICs (application-specific integrated circuits). Any of the various elements of an implementation of an apparatus as disclosed herein may also be embodied as one or more computers (e.g., machines including one or more arrays programmed to execute one or more sets or sequences of instructions, also called “processors”), and any two or more, or even all, of these elements may be implemented within the same such computer or computers.

A processor or other means for processing as disclosed herein may be fabricated as one or more electronic and/or optical devices residing, for example, on the same chip or among two or more chips in a chipset. One example of such a device is a fixed or programmable array of logic elements, such as transistors or logic gates, and any of these elements may be implemented as one or more such arrays. Such an array or arrays may be implemented within one or more chips (for example, within a chipset including two or more chips). Examples of such arrays include fixed or programmable arrays of logic elements, such as microprocessors, embedded processors, IP cores, DSPs, FPGAs, ASSPs, and ASICs. A processor or other means for processing as disclosed herein may also be embodied as one or more computers (e.g., machines including one or more arrays programmed to execute one or more sets or sequences of instructions) or other processors. It is possible for a processor as described herein to be used to perform tasks or execute other sets of instructions that are not directly related to a procedure of an implementation of method M100, such as a task relating to another operation of a device or system in which the processor is embedded (e.g., an audio sensing device). It is also possible for part of a method as disclosed herein to be performed by a processor of the audio sensing device and for another part of the method to be performed under the control of one or more other processors.

Those of skill will appreciate that the various illustrative modules, logical blocks, circuits, and tests and other operations described in connection with the configurations disclosed herein may be implemented as electronic hardware, computer software, or combinations of both. Such modules, logical blocks, circuits, and operations may be implemented or performed with a general purpose processor, a digital signal processor (DSP), an ASIC or ASSP, an FPGA or other programmable logic device, discrete gate or transistor logic, discrete hardware components, or any combination thereof designed to produce the configuration as disclosed herein. For example, such a configuration may be implemented at least in part as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a general purpose processor or other digital signal processing unit. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. A software module may reside in a non-transitory storage medium such as RAM (random-access memory), ROM (read-only memory), nonvolatile RAM (NVRAM) such as flash RAM, erasable programmable ROM (EPROM), electrically erasable programmable ROM (EEPROM), registers, hard disk, a removable disk, or a CD-ROM; or in any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

It is noted that the various methods disclosed herein (e.g., methods M100 and M200 and other methods disclosed by way of description of the operation of the various apparatus described herein) may be performed by an array of logic elements such as a processor, and that the various elements of an apparatus as described herein may be implemented as modules designed to execute on such an array. As used herein, the term “module” or “sub-module” can refer to any method, apparatus, device, unit or computer-readable data storage medium that includes computer instructions (e.g., logical expressions) in software, hardware or firmware form. It is to be understood that multiple modules or systems can be combined into one module or system and one module or system can be separated into multiple modules or systems to perform the same functions. When implemented in software or other computer-executable instructions, the elements of a process are essentially the code segments to perform the related tasks, such as with routines, programs, objects, components, data structures, and the like. The term “software” should be understood to include source code, assembly language code, machine code, binary code, firmware, macrocode, microcode, any one or more sets or sequences of instructions executable by an array of logic elements, and any combination of such examples. The program or code segments can be stored in a processor readable medium or transmitted by a computer data signal embodied in a carrier wave over a transmission medium or communication link.

The implementations of methods, schemes, and techniques disclosed herein may also be tangibly embodied (for example, in tangible, computer-readable features of one or more computer-readable storage media as listed herein) as one or more sets of instructions executable by a machine including an array of logic elements (e.g., a processor, microprocessor, microcontroller, or other finite state machine). The term “computer-readable medium” may include any medium that can store or transfer information, including volatile, nonvolatile, removable, and non-removable storage media. Examples of a computer-readable medium include an electronic circuit, a semiconductor memory device, a ROM, a flash memory, an erasable ROM (EROM), a floppy diskette or other magnetic storage, a CD-ROM/DVD or other optical storage, a hard disk or any other medium which can be used to store the desired information, a fiber optic medium, a radio frequency (RF) link, or any other medium which can be used to carry the desired information and can be accessed. The computer data signal may include any signal that can propagate over a transmission medium such as electronic network channels, optical fibers, air, electromagnetic, RF links, etc. The code segments may be downloaded via computer networks such as the Internet or an intranet. In any case, the scope of the present disclosure should not be construed as limited by such embodiments.

Each of the tasks of the methods described herein may be embodied directly in hardware, in a software module executed by a processor, or in a combination of the two. In a typical application of an implementation of a method as disclosed herein, an array of logic elements (e.g., logic gates) is configured to perform one, more than one, or even all of the various tasks of the method. One or more (possibly all) of the tasks may also be implemented as code (e.g., one or more sets of instructions), embodied in a computer program product (e.g., one or more data storage media such as disks, flash or other nonvolatile memory cards, semiconductor memory chips, etc.), that is readable and/or executable by a machine (e.g., a computer) including an array of logic elements (e.g., a processor, microprocessor, microcontroller, or other finite state machine). The tasks of an implementation of a method as disclosed herein may also be performed by more than one such array or machine. In these or other implementations, the tasks may be performed within a device for wireless communications such as a cellular telephone or other device having such communications capability. Such a device may be configured to communicate with circuit-switched and/or packet-switched networks (e.g., using one or more protocols such as VoIP). For example, such a device may include RF circuitry configured to receive and/or transmit encoded frames.

It is expressly disclosed that the various methods disclosed herein may be performed by a portable communications device such as a handset, headset, or portable digital assistant (PDA), and that the various apparatus described herein may be included within such a device. A typical real-time (e.g., online) application is a telephone conversation conducted using such a mobile device.

In one or more exemplary embodiments, the operations described herein may be implemented in hardware, software, firmware, or any combination thereof. If implemented in software, such operations may be stored on or transmitted over a computer-readable medium as one or more instructions or code. The term “computer-readable media” includes both computer-readable storage media and communication (e.g., transmission) media. By way of example, and not limitation, computer-readable storage media can comprise an array of storage elements, such as semiconductor memory (which may include without limitation dynamic or static RAM, ROM, EEPROM, and/or flash RAM), or ferroelectric, magnetoresistive, ovonic, polymeric, or phase-change memory; CD-ROM or other optical disk storage; and/or magnetic disk storage or other magnetic storage devices. Such storage media may store information in the form of instructions or data structures that can be accessed by a computer. Communication media can comprise any medium that can be used to carry desired program code in the form of instructions or data structures and that can be accessed by a computer, including any medium that facilitates transfer of a computer program from one place to another. Also, any connection is properly termed a computer-readable medium. For example, if the software is transmitted from a website, server, or other remote source using a coaxial cable, fiber optic cable, twisted pair, digital subscriber line (DSL), or wireless technology such as infrared, radio, and/or microwave, then the coaxial cable, fiber optic cable, twisted pair, DSL, or wireless technology such as infrared, radio, and/or microwave are included in the definition of medium. Disk and disc, as used herein, includes compact disc (CD), laser disc, optical disc, digital versatile disc (DVD), floppy disk and Blu-ray Disc™ (Blu-Ray Disc Association, Universal City, Calif.), where disks usually reproduce data magnetically, while discs reproduce data optically with lasers. Combinations of the above should also be included within the scope of computer-readable media.

An acoustic signal processing apparatus as described herein may be incorporated into an electronic device that accepts speech input in order to control certain operations, or may otherwise benefit from separation of desired noises from background noises, such as communications devices. Many applications may benefit from enhancing or separating clear desired sound from background sounds originating from multiple directions. Such applications may include human-machine interfaces in electronic or computing devices which incorporate capabilities such as voice recognition and detection, speech enhancement and separation, voice-activated control, and the like. It may be desirable to implement such an acoustic signal processing apparatus to be suitable in devices that only provide limited processing capabilities.

The elements of the various implementations of the modules, elements, and devices described herein may be fabricated as electronic and/or optical devices residing, for example, on the same chip or among two or more chips in a chipset. One example of such a device is a fixed or programmable array of logic elements, such as transistors or gates. One or more elements of the various implementations of the apparatus described herein may also be implemented in whole or in part as one or more sets of instructions arranged to execute on one or more fixed or programmable arrays of logic elements such as microprocessors, embedded processors, IP cores, digital signal processors, FPGAs, ASSPs, and ASICs.

It is possible for one or more elements of an implementation of an apparatus as described herein to be used to perform tasks or execute other sets of instructions that are not directly related to an operation of the apparatus, such as a task relating to another operation of a device or system in which the apparatus is embedded. It is also possible for one or more elements of an implementation of such an apparatus to have structure in common (e.g., a processor used to execute portions of code corresponding to different elements at different times, a set of instructions executed to perform tasks corresponding to different elements at different times, or an arrangement of electronic and/or optical devices performing operations for different elements at different times).

What is claimed is:

1. A method of using information from a near-end noise reference to process a reproduced audio signal, said method comprising:
applying a subband filter array to the near-end noise reference to produce a plurality of time-domain noise subband signals;
based on information from the plurality of time-domain noise subband signals, calculating a plurality of noise subband excitation values;
based on the plurality of noise subband excitation values, calculating a plurality of subband gain factors; and
applying the plurality of subband gain factors to a plurality of frequency bands of the reproduced audio signal in a time domain to produce an enhanced audio signal,
wherein said calculating a plurality of subband gain factors includes, for each of said plurality of subband gain factors, raising a value that is based on a corresponding noise subband excitation value to a power of alpha to produce a corresponding compressed value, wherein the subband gain factor is based on the corresponding compressed value and wherein alpha has a positive nonzero value that is less than one.

2. The method according to claim 1, wherein, for each of at least one noise subband excitation value in the plurality of noise subband excitation values, the noise subband excitation value is based on a corresponding subband compensation factor, and the corresponding subband compensation factor is based on a width of a passband of a corresponding subband filter.

3. The method according to claim 2, wherein, for each of said at least one noise subband excitation value, the corresponding subband compensation factor is based on a location of a peak response of the corresponding subband filter.

4. The method according to claim 2, wherein, for each of said at least one noise subband excitation value, the corresponding subband compensation factor is based on a relation between (A) a width of a passband of the corresponding subband filter and (B) an equivalent rectangular bandwidth of an auditory filter, wherein said equivalent rectangular bandwidth is based on a location of a peak response of the corresponding subband filter.

5. The method according to claim 4, wherein, for each of said at least one noise subband excitation value, said equivalent rectangular bandwidth is less than half of said passband width of the corresponding subband filter.

6. The method according to claim 1, wherein the subband filter array includes a plurality of biquad filters.

7. The method according to claim 1, wherein, for each of at least one noise subband excitation value in the plurality of noise subband excitation values, said calculating the noise subband excitation value includes estimating a power of a corresponding time-domain noise subband signal of the plurality of time-domain noise subband signals.

8. The method according to claim 7, wherein said estimating a power includes calculating an energy of a frame of the corresponding noise subband signal.

9. The method according to claim 8, wherein said calculating the energy of the frame comprises calculating a sum of squared samples of the frame.

10. The method according to claim 1, wherein alpha has a positive nonzero value that is less than one-half.

11. The method according to claim 1, wherein, for each subband gain factor in said plurality of subband gain factors, said value that is based on the noise subband excitation value is also based on a threshold hearing excitation value.

12. The method according to claim 1, wherein said method comprises filtering the reproduced audio signal using a cascade of filter stages, and
wherein said applying the plurality of subband gain factors to a plurality of frequency bands of the reproduced audio signal in a time domain to produce an enhanced audio signal comprises, for each subband gain factor in the plurality of subband gain factors, using the subband gain factor to vary a gain response of a corresponding filter stage of the cascade.

13. The method according to claim 12, wherein each of the cascade of filter stages is a biquad filter.

14. The method according to claim 12, wherein, for each filter stage in the cascade of filter stages, the filter stage has the same frequency response as a corresponding one of the plurality of subband filters.

15. The method according to claim 1, wherein said method comprises:
applying a second subband filter array to the reproduced audio signal to produce a plurality of time-domain source subband signals; and
based on information from the plurality of time-domain source subband signals, calculating a plurality of source subband excitation values,
wherein each of at least one subband gain factor in the plurality of subband gain factors is based on a corresponding source subband excitation value of the plurality of source subband excitation values.

16. The method according to claim 15, wherein, for each of at least one subband gain factor in the plurality of subband gain factors, said calculating the subband gain factor includes raising a value that is based on a corresponding source subband excitation value in the plurality of source subband excitation values to the power of alpha to produce a corresponding second compressed value, wherein the subband gain factor is based on the corresponding second compressed value.

17. The method according to claim 1, wherein said calculating the plurality of subband gain factors comprises temporally smoothing a first subband gain factor in the plurality of subband gain factors according to a first smoothing factor, and temporally smoothing a second subband gain factor in the plurality of subband gain factors according to a second smoothing factor, and
wherein said method includes:
indicating an onset of activity in a frequency band in the plurality of frequency bands of the reproduced audio signal that corresponds to the first subband gain factor, and
in response to said indicating, selecting the first smoothing factor to have a different value than the second smoothing factor.

18. The method according to claim 1, wherein said calculating the plurality of subband gain factors comprises temporally smoothing at least one subband gain factor in the plurality of subband gain factors according to a smoothing factor, and
wherein said method includes:
indicating a lack of sound activity in the reproduced audio signal, and
in response to said indicating, selecting a value of the smoothing factor.

19. An apparatus for using information from a near-end noise reference to process a reproduced audio signal, said apparatus comprising:
means for filtering the near-end noise reference to produce a plurality of time-domain noise subband signals;
means for calculating, based on information from the plurality of time-domain noise subband signals, a plurality of noise subband excitation values;
means for calculating, based on the plurality of noise subband excitation values, a plurality of subband gain factors; and
means for applying the plurality of subband gain factors to a plurality of frequency bands of the reproduced audio signal in a time domain to produce an enhanced audio signal,
wherein said calculating a plurality of subband gain factors includes, for each of said plurality of subband gain factors, raising a value that is based on a corresponding noise subband excitation value to a power of alpha to produce a corresponding compressed value, wherein the subband gain factor is based on the corresponding compressed value and wherein alpha has a positive nonzero value that is less than one.

20. The apparatus according to claim 19, wherein, for each of at least one noise subband excitation value in the plurality of noise subband excitation values, the noise subband excitation value is based on a corresponding subband compensation factor, and the corresponding subband compensation factor is based on a width of a passband of a corresponding subband filter.

21. The apparatus according to claim 20, wherein, for each of said at least one noise subband excitation value, the corresponding subband compensation factor is based on a location of a peak response of the corresponding subband filter.

22. The apparatus according to claim 20, wherein, for each of said at least one noise subband excitation value, the corresponding subband compensation factor is based on a relation between (A) a width of a passband of the corresponding subband filter and (B) an equivalent rectangular bandwidth of an auditory filter, wherein said equivalent rectangular bandwidth is based on a location of a peak response of the corresponding subband filter.

23. The apparatus according to claim 19, wherein alpha has a positive nonzero value that is less than one-half.

24. The apparatus according to claim 19, wherein, for each subband gain factor in said plurality of subband gain factors, said value that is based on the noise subband excitation value is also based on a threshold hearing excitation value.

25. The apparatus according to claim 19, wherein said means for applying the plurality of subband gain factors comprises means for filtering the reproduced audio signal using a cascade of filter stages, and
wherein said applying the plurality of subband gain factors to a plurality of frequency bands of the reproduced audio signal in a time domain to produce an enhanced audio signal comprises, for each subband gain factor in the plurality of subband gain factors, using the subband gain factor to vary a gain response of a corresponding filter stage of the cascade.

26. The apparatus according to claim 25, wherein each of the cascade of filter stages is a biquad filter.

27. The apparatus according to claim 19, wherein said apparatus comprises:
means for applying a second subband filter array to the reproduced audio signal to produce a plurality of time-domain source subband signals; and
means for calculating, based on information from the plurality of time-domain source subband signals, a plurality of source subband excitation values,
wherein each of at least one subband gain factor in the plurality of subband gain factors is based on a corresponding source subband excitation value of the plurality of source subband excitation values.

28. The apparatus according to claim 27, wherein, for each of at least one subband gain factor in the plurality of subband gain factors, said calculating the subband gain factor includes raising a value that is based on a corresponding source subband excitation value in the plurality of source subband excitation values to the power of alpha to produce a corresponding second compressed value, wherein the subband gain factor is based on the corresponding second compressed value.

29. The apparatus according to claim 19, wherein said calculating the plurality of subband gain factors comprises temporally smoothing a first subband gain factor in the plurality of subband gain factors according to a first smoothing factor, and temporally smoothing a second subband gain factor in the plurality of subband gain factors according to a second smoothing factor, and
wherein said apparatus includes:
means for indicating an onset of activity in a frequency band in the plurality of frequency bands of the reproduced audio signal that corresponds to the first subband gain factor, and
means for selecting, in response to said indicating, the first smoothing factor to have a different value than the second smoothing factor.

30. An apparatus for using information from a near-end noise reference to process a reproduced audio signal, said apparatus comprising:
a subband filter array configured to filter the near-end noise reference to produce a plurality of time-domain noise subband signals;
a first calculator configured to calculate, based on information from the plurality of time-domain noise subband signals, a plurality of noise subband excitation values;
a second calculator configured to calculate, based on the plurality of noise subband excitation values, a plurality of subband gain factors; and
a filter bank configured to apply the plurality of subband gain factors to a plurality of frequency bands of the reproduced audio signal in a time domain to produce an enhanced audio signal,
wherein said second calculator is configured, for each of said plurality of subband gain factors, to raise a value that is based on a corresponding noise subband excitation value to a power of alpha to produce a corresponding compressed value, wherein the subband gain factor is based on the corresponding compressed value and wherein alpha has a positive nonzero value that is less than one.

31. The apparatus according to claim 30, wherein, for each of at least one noise subband excitation value in the plurality of noise subband excitation values, the noise subband excitation value is based on a corresponding subband compensation factor, and the corresponding subband compensation factor is based on a width of a passband of a corresponding subband filter.

32. The apparatus according to claim 31, wherein, for each of said at least one noise subband excitation value, the corresponding subband compensation factor is based on a location of a peak response of the corresponding subband filter.

33. The apparatus according to claim 31, wherein, for each of said at least one noise subband excitation value, the corresponding subband compensation factor is based on a relation between (A) a width of a passband of the corresponding subband filter and (B) an equivalent rectangular bandwidth of an auditory filter, wherein said equivalent rectangular bandwidth is based on a location of a peak response of the corresponding subband filter.

34. The apparatus according to claim 30, wherein alpha has a positive nonzero value that is less than one-half.

35. The apparatus according to claim 30, wherein, for each subband gain factor in said plurality of subband gain factors, said value that is based on the noise subband excitation value is also based on a threshold hearing excitation value.

36. The apparatus according to claim 30, wherein said filter bank includes a cascade of filter stages, and
wherein said filter bank is configured to apply the plurality of subband gain factors to a plurality of frequency bands of the reproduced audio signal in a time domain to produce an enhanced audio signal by, for each subband gain factor in the plurality of subband gain factors, using the subband gain factor to vary a gain response of a corresponding filter stage of the cascade.

37. The apparatus according to claim 36, wherein each of the cascade of filter stages is a biquad filter.

38. The apparatus according to claim 30, wherein said apparatus comprises:
a second subband filter array configured to filter the reproduced audio signal to produce a plurality of time-domain source subband signals; and
a third calculator configured to calculate, based on information from the plurality of time-domain source subband signals, a plurality of source subband excitation values,
wherein each of at least one subband gain factor in the plurality of subband gain factors is based on a corresponding source subband excitation value of the plurality of source subband excitation values.

39. The apparatus according to claim 38, wherein, for each of at least one subband gain factor in the plurality of subband gain factors, said calculating the subband gain factor includes raising a value that is based on a corresponding source subband excitation value in the plurality of source subband excitation values to the power of alpha to produce a corresponding second compressed value, wherein the subband gain factor is based on the corresponding second compressed value.

40. The apparatus according to claim 30, wherein said second calculator includes a smoother configured to temporally smooth a first subband gain factor in the plurality of subband gain factors according to a first smoothing factor, and to temporally smooth a second subband gain factor in the plurality of subband gain factors according to a second smoothing factor, and
wherein said apparatus includes an activity detector configured to indicate an onset of activity in a frequency band in the plurality of frequency bands of the reproduced audio signal that corresponds to the first subband gain factor, and
wherein said smoother is configured to select, in response to said indicating, the first smoothing factor to have a different value than the second smoothing factor.

41. A non-transitory computer-readable data storage medium having tangible features that cause a machine reading the features to perform a method according to claim 1.
